(19) United States
(12) Patent Application Publication
(10) Pub. No.: US 2026/0016787 A1
(43) Pub. Date: Jan. 15, 2026

(54) IMAGE FORMING APPARATUS

(71) Applicant: CANON KABUSHIKI KAISHA, Tokyo (JP)

(72) Inventor: TSUKASA ABE, Kanagawa (JP)

(21) Appl. No.: 19/252,121

(22) Filed: Jun. 27, 2025

(30) Foreign Application Priority Data
Jul. 10, 2024 (JP) 2024-111319

(51) Int. Cl. G03G 21/18; G03G 15/01; G03G 21/16

(52) U.S. Cl. CPC G03G 21/1871; G03G 15/0189; G03G 21/1619; G03G 21/1633; G03G 21/1647; G03G 21/1814; G03G 21/1885

(57) ABSTRACT

An image forming apparatus includes a casing, a cartridge detachably attached to the casing, a first contact disposed in the casing, and a second contact disposed in the cartridge. The casing includes a first side plate and a second side plate. The first side plate includes a first surface and a first protruding portion. The cartridge includes a second surface and a second protruding portion. The first contact is movable between a contact position and a separated position. At the separated position, the first contact protrudes in the first direction relative to the first surface, and is retracted in the opposite direction relative to a maximum protruding position of the first protruding portion with respect to the first surface.

### BACKGROUND

### Field of the Technology

The present disclosure relates to an image forming apparatus that forms an image on a recording material.

### Description of the Related Art

Japanese Patent Laid-open No. 2014-106392 describes that an electrical contact of an apparatus body is brought into contact with and separated from an electrical contact of a cartridge in conjunction with opening and closing of a door with respect to the apparatus body of an image forming apparatus.

### SUMMARY

The present disclosure provides a new technology related to bringing a contact provided in a casing of an image forming apparatus and a contact provided in a cartridge into contact with each other.

According to an aspect of the disclosure, an image forming apparatus includes a casing, a cartridge detachably attached to the casing, a first contact disposed in the casing, and a second contact disposed in the cartridge and configured to electrically connect the cartridge and the casing by contact with the first contact, wherein the casing includes a first side plate and a second side plate between which a space to accommodate the cartridge is formed, wherein the first side plate includes a first surface facing a first direction, which is a direction from the first side plate toward the second side plate, and a first protruding portion protruding in the first direction with respect to the first surface, wherein the cartridge includes a second surface facing an opposite direction opposite to the first direction and a second protruding portion protruding in the opposite direction with respect to the second surface, and is configured such that the first protruding portion faces the second surface and the second protruding portion faces the first surface in a state where the cartridge is attached to the casing, wherein the second contact is disposed inside an outer edge of the second surface when viewed in the first direction and is retracted in the first direction relative to the second surface, wherein the first contact is movable between a contact position, where the first contact is in contact with the second contact, and a separated position, where the first contact is separated from the second contact in the opposite direction, and wherein at the separated position, the first contact protrudes in the first direction relative to the first surface, and is retracted in the opposite direction relative to a maximum protruding position of the first protruding portion with respect to the first surface.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view of a printer according to Example 1.

FIG. 2 is a view for explaining the printer according to Example 1.

FIG. 3 is a view for explaining the printer according to Example 1.

FIG. 4 is a view for explaining the printer according to Example 1.

FIG. 5 is a view for explaining the printer according to Example 1.

FIG. 6 is a view for explaining the printer according to Example 1.

FIG. 7 is a view for explaining the printer according to Example 1.

FIG. 8A is a view for explaining a moving member and a link mechanism according to Example 1.

FIG. 8B is a view for explaining the moving member and the link mechanism according to Example 1.

FIG. 8C is a view for explaining the moving member and the link mechanism according to Example 1.

FIG. 8D is a view for explaining the moving member and the link mechanism according to Example 1.

FIG. 8E is a view for explaining the moving member and the link mechanism according to Example 1.

FIG. 8F is a view for explaining the moving member and the link mechanism according to Example 1.

FIG. 9 is a view for explaining an apparatus body according to Example 1.

FIG. 10 is a view for explaining the apparatus body according to Example 1.

FIG. 11 is a perspective view of a tray unit according to Example 1.

FIG. 12A is a view illustrating the printer in a state where a door is closed according to Example 1.

FIG. 12B is a cross-sectional view taken along line A-A′ in FIG. 12A.

FIG. 13A is a view illustrating the printer in a state where the door is opened according to Example 1.

FIG. 13B is a cross-sectional view taken along line A-A′ in FIG. 13A.

FIG. 14 is an assembled view of a left side plate and a holder, with a partially enlarged view of the holder, according to Example 1.

FIG. 15 is a cross-sectional view of an example of a cartridge.

FIG. 16 is an exploded view of a drum unit in an example of a cartridge.

FIG. 17 is an exploded view of a developing unit in an example of a cartridge.

FIG. 18 is an assembly view of an example of a cartridge.

FIG. 19 is a perspective view of an example of a cartridge.

FIG. 20 is a schematic view of a remaining toner amount detection mechanism in an example of a cartridge.

FIG. 21 is a perspective view illustrating an end on a non-drive side in an example of a cartridge.

FIG. 22 is a side view illustrating an end on a non-drive side in an example of a cartridge.

### DESCRIPTION OF THE EMBODIMENTS

Hereinafter, an embodiment according to the present disclosure will be described with reference to the drawings.

### Example 1

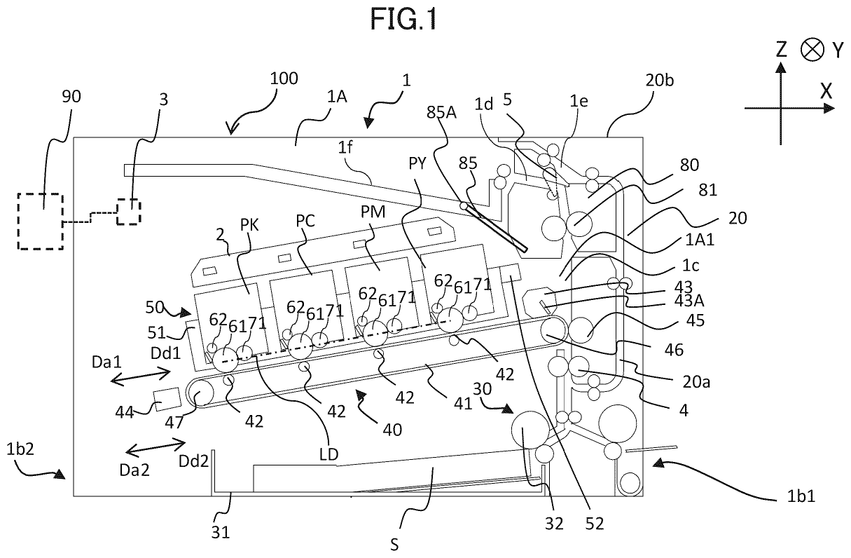

A printer 1 will be described with reference to FIG. 1 as an image forming apparatus according to an embodiment (Example 1). FIG. 1 is a schematic view illustrating an overall configuration of the printer 1 according to the present example. The printer 1 is an electrophotographic color laser beam printer that forms an image on a sheet S serving as a recording material.

In the following description and drawings, an up-down direction when the printer 1 is installed on a horizontal plane is defined as a Z-axis direction. A rotation axis direction of a photosensitive drum 61 included in the printer 1 is defined as a Y-axis direction. A direction intersecting both the Z-axis direction and the Y-axis direction is defined as an X-axis direction. The X-axis direction, the Y-axis direction, and the Z-axis direction are preferably orthogonal to each other. One side in the X-axis direction (a side indicated by arrow X) may be referred to as a +X side or a +X direction, and the other side in the X-axis direction may be referred to as a −X side or a −X direction. Similarly, one side in the Y-axis direction (a side indicated by arrow Y) may be referred to as a +Y side or a +Y direction, the other side in the Y-axis direction may be referred to as a −Y side or a −Y direction, one side in the Z-axis direction (a side indicated by arrow Z) may be referred to as a +Z side or a +Z direction, and the other side in the Z-axis direction may be referred to as a −Z side or a −Z direction.

The +X direction can be referred to as a front side (forward side) of the printer 1. In addition, the +Y side can be referred to as a right side, and the −Y side can be referred to as a left side in a state where the printer 1 is viewed from the front side.

As illustrated in FIG. 1, the printer 1 includes an apparatus body 1A (casing), a scanner 2 serving as an exposing unit, a control unit 3, and a door 20 serving as an opening/closing member. Further, the printer 1 includes a sheet feeding unit 30, a transfer unit 40, a tray unit (moving unit) 50, and a fixing unit 80. A portion including the apparatus body 1A and the door 20 can also be referred to as a main frame 100 of the printer 1. The main frame 100 includes an exterior portion of the printer 1.

The apparatus body 1A houses the scanner 2, the control unit 3, the sheet feeding unit 30, the transfer unit 40, a secondary transfer roller 45, the tray unit 50, and the fixing unit 80.

The sheet feeding unit 30 includes a stacking tray 31 (cassette) on which sheets S serving as a recording material are stacked, and a feed roller 32 serving as a feeding member that feeds the sheets S. The stacking tray 31 can be pulled out toward the door 20 to replenish sheets S. In the present example, the direction in which the door 20 is opened and the direction in which the stacking tray 31 is pulled out are the same direction, that is, +X side.

The tray unit 50 includes a tray 51 (support member or drawer) and cartridges PY, PM, PC, and PK. The tray 51 includes a tray handle 52 (grip portion). The cartridges PY, PM, PC, and PK are detachably (removably) attached to the tray 51.

Each of the cartridges PY, PM, PC, and PK is independently attachable to and detachable from the tray 51. The cartridges PY, PM, PC, and PK contain toners (developers) of yellow (Y), magenta (M), cyan (C), and black (K), respectively. The cartridges PY, PM, PC, and PK have the same configuration except that the colors of the toners contained therein are different. Therefore, the configuration and operation of one of the cartridges PY, PM, PC, and PK will be described, and description of the other cartridges may be omitted. In addition, when it is not necessary to distinguish the cartridges PY, PM, PC, and PK, the cartridges PY, PM, PC, and PK may also be simply referred to as cartridges P. It can be said that the tray unit 50 includes a plurality of cartridges P and a tray 51 to which the plurality of cartridges P is detachably attached.

In the present example, the tray unit 50 includes a plurality of photosensitive drums (image bearing members) 61, a plurality of charging rollers 62 (charging members), and a plurality of developing rollers (developing members and developer bearing members) 71. Specifically, the tray unit 50 includes four photosensitive drums 61, four charging rollers 62, and four developing rollers 71. The rotation axis direction of each photosensitive drum 61, the rotation axis direction of each developing roller 71, and the rotation axis direction of each charging roller 62 are substantially parallel to each other.

A portion of the tray unit 50 on which a black image is formed can be referred to as a black station (first station), the photosensitive drum 61 of the first station can be referred to as a first photosensitive drum, the developing roller 71 of the first station can be referred to as a first developing roller, and the charging roller 62 of the first station can be referred to as a first charging roller. A portion of the tray unit 50 on which a cyan image is formed can be referred to as a cyan station (second station), the photosensitive drum 61 of the second station can be referred to as a second photosensitive drum, the developing roller 71 of the second station can be referred to as a second developing roller, and the charging roller 62 of the second station can be referred to as a second charging roller. A portion of the tray unit 50 on which a magenta image is formed can be referred to as a magenta station (third station), the photosensitive drum 61 of the third station can be referred to as a third photosensitive drum, the developing roller 71 of the third station can be referred to as a third developing roller, and the charging roller 62 of the third station can be referred to as a third charging roller. A portion of the tray unit 50 on which a yellow image is formed can be referred to as a yellow station (fourth station), the photosensitive drum 61 of the fourth station can be referred to as a fourth photosensitive drum, the developing roller 71 of the fourth station can be referred to as a fourth developing roller, and the charging roller 62 of the fourth station can be referred to as a fourth charging roller.

The cartridge PK attached to the tray 51 constitutes at least a part of the black station. The cartridge PC attached to the tray 51 constitutes at least a part of the cyan station. The cartridge PM attached to the tray 51 constitutes at least a part of the magenta station. The cartridge PY attached to the tray 51 constitutes at least a part of the yellow station. The cartridge PK can be referred to as a first cartridge, the cartridge PC can be referred to as a second cartridge, the cartridge PM can be referred to as a third cartridge, and the cartridge PY can be referred to as a fourth cartridge.

Note that ordinal numbers such as first, second, third, and fourth in the above description are used for convenience of explanation.

It is only required that the photosensitive drum 61, the charging roller 62, and the developing roller 71 be provided in either the cartridge P or the tray 51. In the present example, the photosensitive drum 61, the charging roller 62, and the developing roller 71 are provided in the cartridge P.

The transfer unit 40 includes a belt 41, a primary transfer roller 42, a cleaning unit 43, a driving roller 46 that drives the belt 41, and a tension roller 47. The printer 1 also includes an optical sensor 44 that detects a toner image transferred onto the belt 41. In the present example, the belt 41 is disposed below the photosensitive drum 61, and can abut on the photosensitive drum 61 such that a primary transfer portion is formed between the belt 41 and the photosensitive drum 61.

The printer 1 also includes a secondary transfer roller 45 that abuts on the belt 41 to form a secondary transfer portion. The secondary transfer portion is formed between the belt 41 and the secondary transfer roller 45. The rotation axis direction of the primary transfer roller 42, the rotation axis direction of the driving roller 46, the rotation axis direction of the tension roller 47, and the rotation axis direction of the secondary transfer roller 45 are substantially parallel to each other. A registration roller pair 4 is disposed upstream of the secondary transfer portion in a direction in which the sheet S is conveyed.

The fixing unit 80 includes a fixing portion 81 and a switching guide 5. The fixing unit 80 of the present example is movable with respect to the apparatus body 1A between a usable position and a retracted position. When an image forming operation is performed, the fixing unit 80 is located at the usable position. The fixing unit 80 is housed in (inside) the apparatus body 1A in a state where it is located at the usable position. Further, the fixing unit 80 is configured to heat the sheet S in a state where it is located at the usable position. The fixing portion 81 includes a heating unit (heating roller) including a heater (heat source) and a pressurizing unit (pressurizing roller) that forms a fixing nip together with the heating unit.

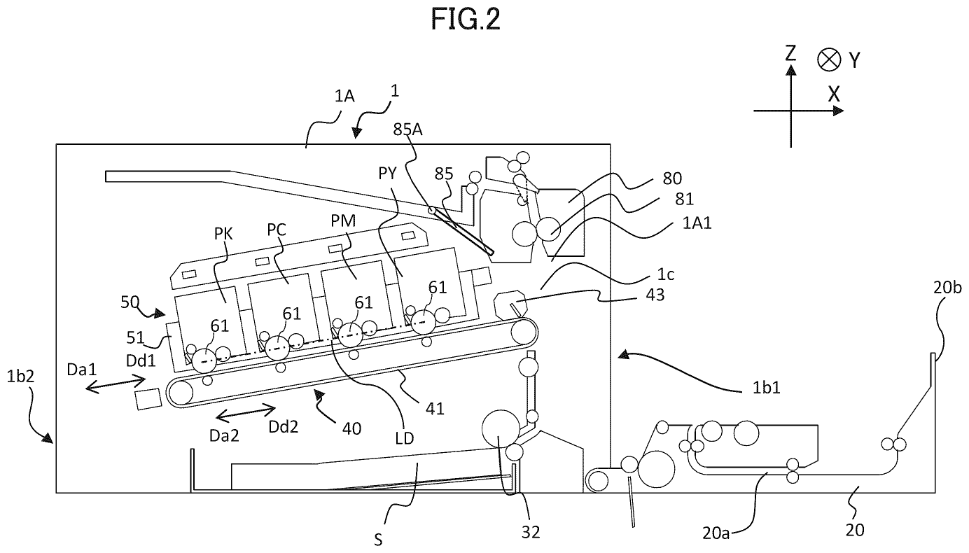

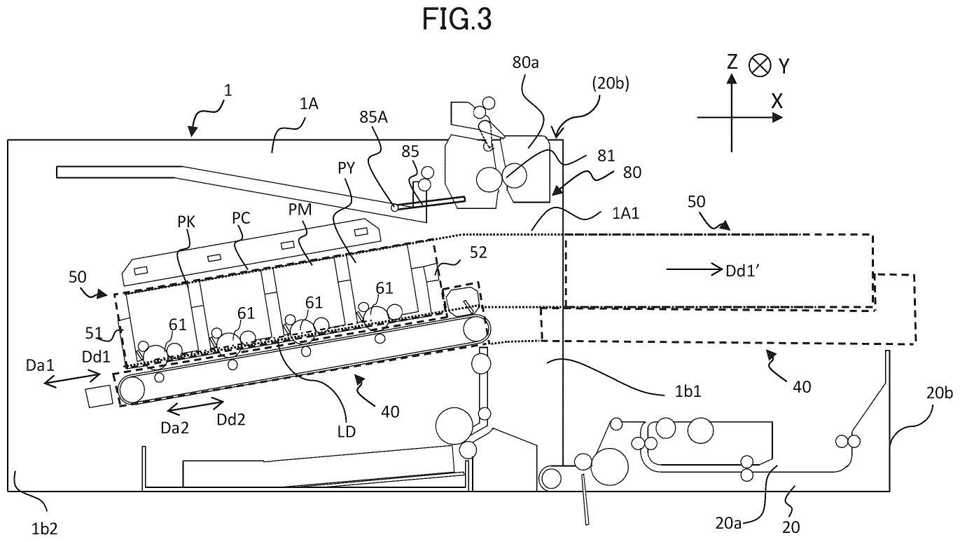

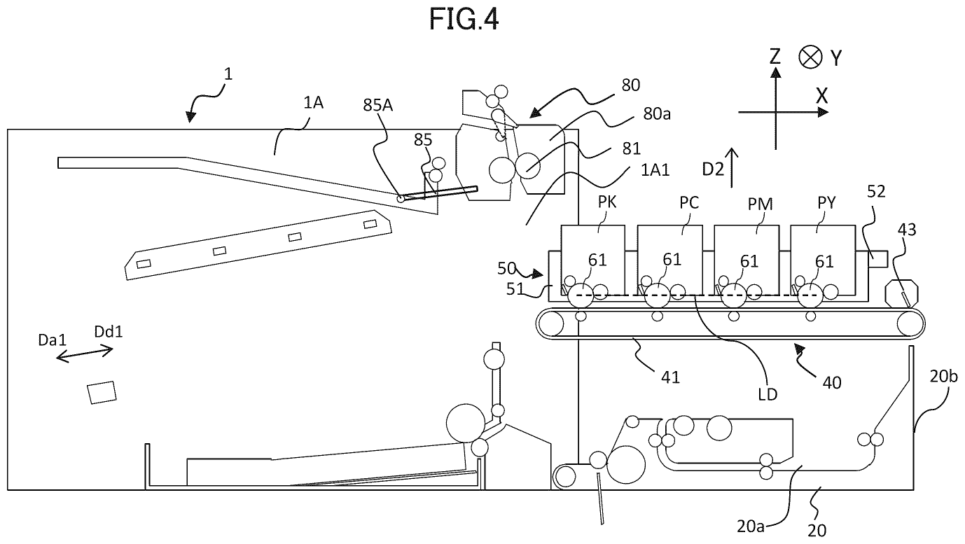

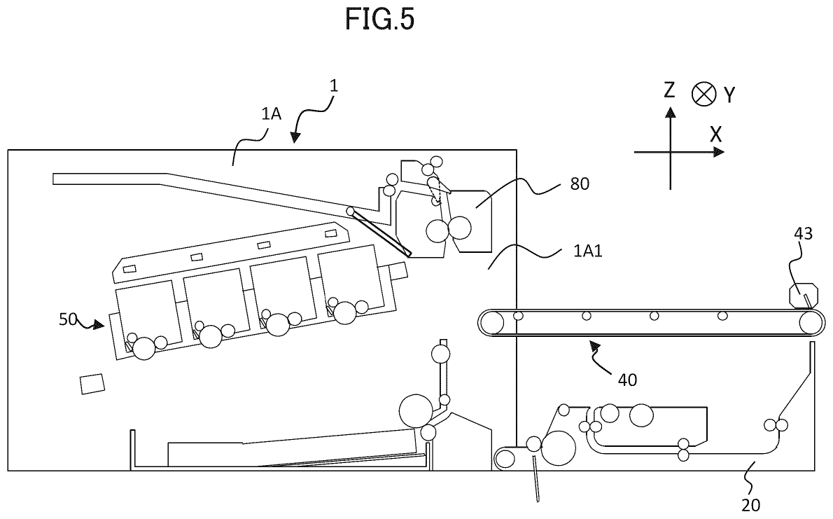

The movement of the transfer unit 40 and the tray unit 50 will be described with reference to FIGS. 1, 2, 3, 4, and 5. FIG. 1 is a view illustrating the printer 1 in a state where the door 20 is closed. FIG. 2 is a view illustrating the printer 1 in a state where the door 20 is opened. FIG. 3 is a view illustrating the printer 1 in a state where the fixing unit 80 has moved to the retracted position. FIG. 4 is a view illustrating the printer 1 in a state where the transfer unit 40 and the tray unit 50 are pulled out. FIG. 5 is a view illustrating the printer 1 in a state where the transfer unit 40 is pulled out alone.

As illustrated in FIGS. 3 to 5, the transfer unit 40 and the tray unit 50 are movable from the inside to the outside of the apparatus body 1A. In the horizontal direction (X-axis direction) when the printer 1 is viewed in the Y-axis direction, the apparatus body 1A has a first end 1b1 where an opening 1A1 is provided and a second end 1b2 located opposite to the first end 1b1. The tray unit 50 is movable between a first inner position inside the apparatus body 1A and a first outer position outside the apparatus body 1A through the opening 1A1. The transfer unit 40 is movable between a second inner position inside the apparatus body 1A and a second outer position outside the apparatus body 1A through the opening 1A1. The opening 1A1 may include an opening through which the tray unit 50 passes and an opening through which the transfer unit 40 passes. When the transfer unit 40 moves from the second inner position to the second outer position, at least the belt 41 is moved, and at least a part of the belt 41 protrudes from the apparatus body 1A toward the outside of the apparatus body 1A.

The direction in which the tray unit 50 moves from the first inner position to the first outer position will be referred to as a tray detachment direction Dd1, and a direction opposite to the tray detachment direction Dd1 will be referred to as a tray attachment direction Da1. The tray detachment direction Dd1 can be said to be a direction from the second end 1b2 to the first end 1b1 in the horizontal direction (X-axis direction). In addition, it can be said that the opening 1A1 is formed in a side surface portion on the downstream side in the tray detachment direction Dd1 of the apparatus body 1A (casing). The tray detachment direction Dd1 and the tray attachment direction Da1 intersect a direction in which the cartridge P is attached to the tray 51.

In the present example, the moving direction of the tray unit 50 changes in the course of the tray unit 50 moving from the first inner position to the first outer position. The change in the moving direction of the tray unit 50 will be described below. In the following description, the tray detachment direction Dd1 refers to a moving direction when the tray unit 50 attached to the apparatus body 1A starts to move toward the outside of the apparatus body 1A. The tray detachment direction Dd1 is a moving direction when the tray 51 is pulled out from a state in which it is inserted in the apparatus body 1A (casing). As a modification, the tray unit 50 may linearly move from the first inner position to the first outer position without changing the moving direction.

The direction in which the transfer unit 40 moves from the second inner position to the second outer position will be referred to as a transfer detachment direction Dd2, and the direction opposite to the transfer detachment direction Dd2 will be referred to as a transfer attachment direction Da2. In the transfer detachment direction Dd2, the driving roller 46 is located downstream of the tension roller 47. The transfer detachment direction Dd2 can be referred to as a direction from the second end 1b2 to the first end 1b1 in the horizontal direction (X-axis direction).

The tray detachment direction Dd1 and the tray attaching direction Da1 are directions intersecting the rotation axis direction of the photosensitive drum 61 (preferably, directions orthogonal to the rotation axis direction of the photosensitive drum 61). The transfer detachment direction Dd2 and the transfer attachment direction Da2 are directions intersecting the rotation axis direction of the driving roller 46 (preferably, directions orthogonal to the rotation axis direction of the driving roller 46). The rotation axis direction of the driving roller 46 is parallel to the rotation axis direction of the photosensitive drum 61.

The fixing unit 80 described above is disposed on one end side (the side where the first end 1b1 is disposed) of the apparatus body 1A in the horizontal direction (X-axis direction).

The door 20 is an opening/closing member (cover member or front cover) movable with respect to the apparatus body 1A between a closed position and an opened position. As illustrated in FIG. 1, in a state where the door 20 is located at the closed position (in a state where the door 20 is closed), the door 20 covers the opening 1A1. As illustrated in FIG. 2, in a state where the door 20 is located at the opened position (in a state where the door 20 is opened), the opening 1A1 is exposed.

As illustrated in FIG. 1, in a state where the door 20 is located at the closed position, the door 20 covers the fixing unit 80 attached to the apparatus body 1A. More specifically, in a state where the door 20 is located at the closed position, an upper cover portion 20b of the door 20 is located above the fixing unit 80. The upper cover portion 20b of the door 20 has a function as a part of the exterior portion. In a state where the door 20 is located at the closed position, the printer 1 executes an image forming operation. In a state where the door 20 is located at the opened position, the tray unit 50 and the transfer unit 40 are allowed to be pulled out from the apparatus body 1A through the opening 1A1.

The door 20 can move between the opened position and the closed position while the fixing unit 80 is supported by the apparatus body 1A. In other words, the door 20 moves from the closed position to the opened position so as to be separated from the fixing unit supported by the apparatus body 1A. Therefore, as illustrated in FIG. 2, in a state where the door 20 is located at the opened position, the door 20 is separated from the fixing unit 80 supported by the apparatus body 1A.

The fixing unit 80 is movable (retractable) from the usable position illustrated in FIG. 2 to the retracted position illustrated in FIG. 3 so that the opening 1A1 is widely exposed. In a state where the door 20 and the fixing unit 80 have moved (FIG. 3), the transfer unit 40 and the tray unit 50 are movable from the inside to the outside of the apparatus body 1A through the opening 1A1, and the state of FIG. 4 is obtained after the movement. That is, in the present example, the tray unit 50 and the transfer unit 40 are allowed to be pulled out from the apparatus body 1A in a state where the door 20 is located at the opened position and the fixing unit 80 is moved to the retracted position. Note that the fixing unit 80 may be fixed to the apparatus body 1A, and the tray unit 50 and the transfer unit 40 may be allowed to be pulled out from the apparatus body 1A by opening the door 20.

In a state where the tray unit 50 has moved to the outside of the apparatus body 1A (FIG. 4), it is allowed to remove the cartridges PY, PM, PC, and PK from the tray 51 and attach the cartridges PY, PM, PC, and PK to the tray 51. Each of the cartridges PY to PK is disengaged from the tray 51 in a disengagement direction D2 intersecting the tray detachment direction Dd1. Accordingly, the cartridges PY, PM, PC, and PK can be replaced with new cartridges PY, PM, PC, and PK. In the present example, the cartridge P is attachable to and detachable from the tray 51 in a direction intersecting the rotation axis of the photosensitive drum 61 (preferably, a direction orthogonal to the rotation axis of the photosensitive drum 61). Specifically, in a state where the tray 51 has been pulled out from the apparatus body 1A, the cartridge P of the present example is detached from the tray 51 in a substantially upward direction (substantially +Z direction), and is attached to the tray 51 in a substantially downward direction (substantially −Z direction).

The cartridges PY, PM, PC, and PK are detached from the tray 51 by moving in a direction away from the transfer unit 40 with respect to the tray 51. In other words, the cartridges PY, PM, PC, and PK move toward the side opposite to the transfer unit 40 with respect to the tray 51, and are detached from the tray 51. In the present example, the transfer unit 40 is disposed below the tray unit 50. Therefore, the cartridges PY, PM, PC, and PK move upward with respect to the tray 51, and are detached from the tray 51.

Further, the transfer unit 40 can be detached from the apparatus body 1A independently of the tray unit 50, and can be replaced with a new transfer unit 40.

### Image Forming Operation

An image forming operation, which is a series of operations in which the printer 1 forms an image on the sheet S while conveying the sheet S, will be described with reference to FIG. 1. The control unit 3 of the printer 1 starts an image forming operation based on image information received from an external host apparatus 90. The external host apparatus 90 is, for example, a personal computer, an image reader, a facsimile, or the like.

When the image forming operation is performed, the fixing unit 80 is located at the usable position, the tray unit 50 is located at the first inner position, the transfer unit 40 is located at the second inner position, and the door 20 is located at the closed position. In a state where the transfer unit 40 is located at the second inner position, the belt 41 can abut on the photosensitive drum 61. The positions of the cartridges PY to PK when the tray unit 50 is located at the first inner position and the door 20 is located at the closed position are defined as image forming positions. When the tray unit 50 is located at the first inner position and the transfer unit 40 is located at the second inner position, the tray unit 50 is located above the transfer unit 40.

When the image forming operation is started, the photosensitive drum 61 is driven to rotate in each station of the tray unit 50, and the charging roller 62 to which a charging voltage is applied uniformly charges the surface of the photosensitive drum 61. In addition, each of the photosensitive drums 61 is irradiated with a laser corresponding to the image information from the scanner 2, and the surface of the photosensitive drum 61 is exposed. As a result, an electrostatic latent image corresponding to an image obtained by decomposing the original image information into CMYK color components is formed on the surface of the photosensitive drum 61.

The developing roller 71 rotates with the toner being borne thereon. A developing voltage is applied to the developing roller 71, and the electrostatic latent image formed on the photosensitive drum 61 is developed by the toner supplied from the developing roller 71, forming a toner image on the surface of the photosensitive drum 61. In the present example, the developing roller 71 develops the electrostatic latent image in a state where the developing roller 71 abuts on the photosensitive drum 61 (contact developing method). However, the developing roller 71 may develop the electrostatic latent image in a state where there is a gap between the developing roller 71 and the photosensitive drum 61. When a full-color image is formed, a toner image of each color is formed on each of the photosensitive drums 61.

In the present example, in a state where the tray unit 50 is located at the first inner position, the developing roller 71 is movable between an abutting position where the developing roller 71 abuts on the photosensitive drum 61 and a separated position where the developing roller 71 is separated from the photosensitive drum 61. Specifically, the state in which the developing roller 71 is located at the abutting position and the state in which the developing roller 71 is located at the separated position are switched by a switching device provided in the apparatus body 1A. As a result, the developing roller 71 can be separated from the photosensitive drum 61 in a state where the image forming operation is not performed.

In addition, the printer 1 can perform monochrome printing in a state where the developing roller 71 and the photosensitive drum 61 corresponding to the cartridge PK abut on each other, and the developing roller 71 and the photosensitive drum 61 corresponding to each of the cartridges PY, PM, and PC are separated from each other. In addition, the printer 1 can perform full-color printing in a state where the photosensitive drums 61 corresponding to the cartridges PY, PM, PC, and PK abut on the belt 41.

The toner image formed on each photosensitive drum 61 is transferred onto the belt 41 by the primary transfer roller 42 in the primary transfer portion. The toner image borne on the belt 41 is conveyed toward the secondary transfer portion formed by the belt 41 and the secondary transfer roller 45.

On the other hand, a conveyance path 1c (first route or first conveyance path) from the feed roller 32 to the fixing unit 80 via the secondary transfer portion is formed in the apparatus body 1A. In addition, a duplex conveyance path (second route or second conveyance path) 20a through which the sheet S having passed through the fixing unit 80 passes is formed in the door 20. The door 20 covers the conveyance path 1c in the closed state. When the door 20 is opened, at least a part of the conveyance path 1c and at least a part of the duplex conveyance path 20a are exposed (FIG. 2).

In the image forming operation, the sheets S are fed one by one from the sheet feeding unit 30 toward the secondary transfer portion through the conveyance path 1c in parallel with the formation of the toner image described above. Specifically, among the sheets S stacked on the stacking tray 31, the uppermost sheet S is fed out by the feed roller 32 at a predetermined timing. The fed-out sheet S is separated by a separating member such as a friction roller, further subjected to skew correction and timing adjustment by the registration roller pair 4, and sent to the secondary transfer portion. In the secondary transfer portion, a toner image is transferred from the belt 41 onto the sheet S by applying a voltage to the secondary transfer roller 45. The toner that has not been transferred onto the sheet S is removed from the belt 41 by a cleaning blade 43A (cleaning member) provided in the cleaning unit 43.

The sheet S onto which the toner image has been transferred in the secondary transfer portion is conveyed to the fixing unit 80. The sheet S is heated and pressurized in the fixing portion 81, and the toner image is fixed onto the sheet S. The sheet S having passed through the fixing portion 81 reaches the switching guide 5 serving as a route switching unit.

The switching guide 5 is movable between a sheet discharge position, where the sheet S having passed through the fixing unit 80 is guided toward a discharge path 1d, and a reversing position, where the sheet S having passed through the fixing unit 80 is guided toward a reversing path le. When single-sided printing, in which an image is formed on one side of the sheet S, is performed, the sheet S is guided to the discharge path 1d by the switching guide 5, and discharged to a sheet discharge tray If formed in an upper portion of the apparatus body 1A. On the other hand, when duplex printing, in which images are printed on one side and the other side of the sheet S, is performed, the sheet S is guided to the reversing path le by the switching guide 5. After the sheet S is guided to the reversing path le, the direction in which the sheet S is conveyed is reversed, and the sheet S is conveyed toward the secondary transfer portion through the duplex conveyance path 20a formed in the door 20. Thereafter, after a toner image is transferred onto the back surface of the sheet S in the secondary transfer portion, the sheet S passes through the fixing unit 80, is guided to the discharge path 1d by the switching guide 5, and is discharged to the sheet discharge tray If of the apparatus body 1A.

### Removal of Tray Unit and Transfer Unit and Arrangement of Fixing Unit

The removal of the tray unit 50 and the transfer unit 40 from the apparatus body 1A and the arrangement of the fixing unit 80 will be described with reference to FIGS. 1, 2, 3, 4, and 5.

As described above, the fixing unit 80 of the printer 1 is disposed on one end side of the apparatus body 1A in the horizontal direction. The transfer unit 40 and the tray unit 50 move from one end side of the apparatus body 1A to the outside of the apparatus body 1A through the opening 1A1.

In other words, the fixing unit 80 is closer to the first end 1b1 than the second end 1b2 in the horizontal direction (X-axis direction). That is, a distance between the fixing unit 80 and the first end 1b1 is shorter than a distance between the fixing unit 80 and the second end 1b2 in the horizontal direction (X-axis direction). The fixing unit 80 is disposed at a position closer to the first end 1b1 than the center of the apparatus body 1A in the horizontal direction (X-axis direction), and it can be said that a distance between the first end 1b1 and the fixing unit 80 is shorter than a distance between the first end 1b1 and the center of the apparatus body 1A in the horizontal direction.

As described above, when the tray unit 50 moves from the first inner position to the first outer position, the moving direction of the tray unit 50 is a direction intersecting the rotation axis of the photosensitive drum 61. At this time, the tray unit 50 moves away from the second end 1b2.

As described above, when the transfer unit 40 moves from the second inner position to the second outer position, the moving direction of the transfer unit 40 is a direction intersecting the rotation axis of the driving roller 46. At this time, the transfer unit 40 moves away from the second end 1b2.

As described above, the door 20 of the present example in the closed state covers the opening 1A1 and covers at least a part of the conveyance path 1c for the sheet S. In addition, the door 20 includes a duplex conveyance path 20a. When the sheet S is jammed (hereinafter, referred to as a jam), the user of the printer 1 can solve the jam by removing the sheet S from one end side of the apparatus body 1A. Specifically, the sheet S can be removed by moving the door 20 to the opened position to access the inside of the apparatus body 1A. When a part of the sheet S having passed through the fixing unit 80 is exposed to the outside of the apparatus body 1A, the sheet S can be removed by pulling the sheet S from the outside of the apparatus body 1A without opening the door 20.

Furthermore, the user of the printer 1 can move the transfer unit 40 and the tray unit 50 from one end side of the apparatus body 1A to the outside of the apparatus body 1A to check the state of the transfer unit 40 or the cartridge P or perform maintenance, replacement, or another operation.

That is, in the printer 1, while the fixing unit 80 is disposed on one end side of the apparatus body 1A, the transfer unit 40 and the tray unit 50 are movable between the inside and the outside of the apparatus body 1A through one end side of the apparatus body 1A. As a result, the user can resolve the jam, access the fixing unit 80, and operate the transfer unit 40 and the tray unit 50 from one direction.

In the printer 1 of the present example, the door 20 side (+X side) is defined as the front. Therefore, it is only required to secure a space for performing operations such as resolving the jam and operating the transfer unit 40 and the tray unit 50 from the front of the printer 1. On the other hand, spaces for performing these operations from the left, the right, the back, and the top of the printer 1 can be omitted. Therefore, the printer 1 can be installed in a space-saving manner.

If the transfer unit 40 or the tray unit 50 is pulled out from the other end side of the apparatus body 1A, the user needs to access both end sides of the apparatus body 1A in order to solve the jam and pull out the transfer unit 40 or the tray unit 50. In addition, in a case where one of the transfer unit 40 and the tray unit 50 is pulled out from one end side of the apparatus body 1A and the other of the transfer unit 40 and the tray unit 50 is pulled out from the other end side of the apparatus body 1A, the user also needs to access both end sides of the apparatus body 1A. For this reason, a space is required for working from the back of the apparatus body 1A as well as the front of the apparatus body 1A, and the area required for installing the printer 1 increases.

Furthermore, in the present example, sheets S can be replenished from one end side of the apparatus body 1A. Therefore, it is only required to secure a space for replenishing sheets S from the front of the printer 1, and the printer 1 can be installed in a space-saving manner.

### Relationship between Tray Unit and Fixing Unit

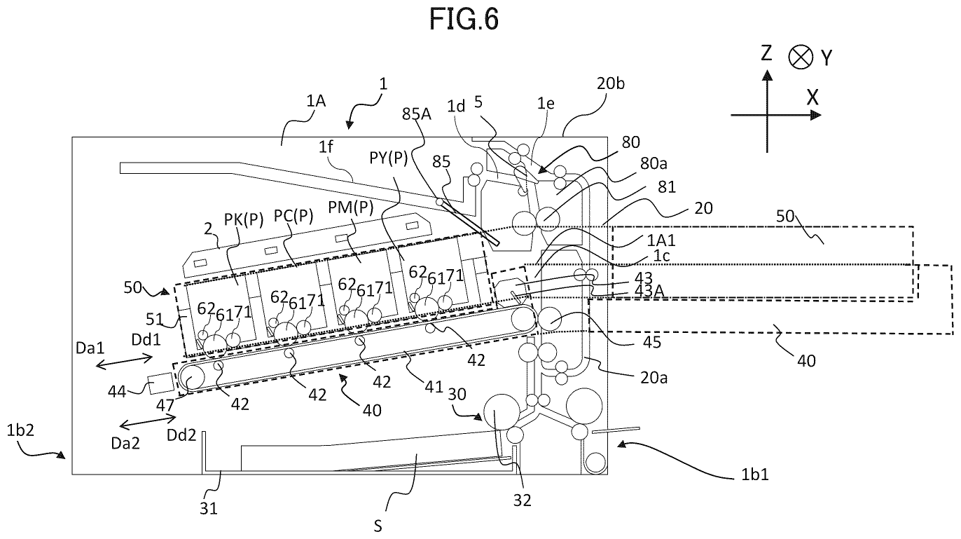

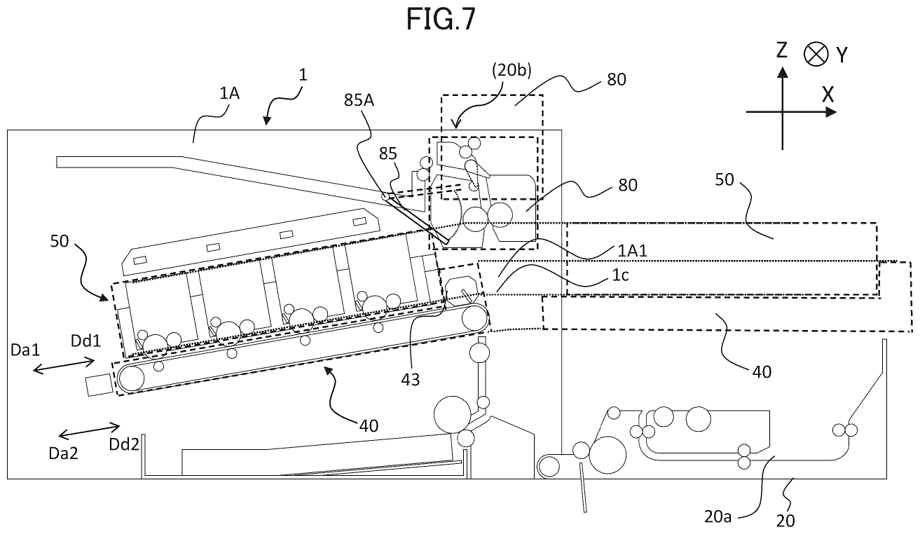

A relationship between the tray unit 50 and the fixing unit 80 will be described with reference to FIGS. 1, 2, 3, 4, 6, and 7. FIGS. 6 and 7 are views for explaining movement of the transfer unit 40 and the tray unit 50.

The tray unit 50 passes through a predetermined space when moving between the first inner position, where the image forming operation is performed, and the first outer position, where replacement of the cartridge P is allowed. The space through which the tray unit 50 passes when moving from the first inner position to the first outer position will be referred to as a first space (a space for moving the tray unit 50). The first space can also be referred to as a route or a track (first moving route or first moving track) through which the tray unit 50 passes when moving from the first inner position to the first outer position.

The transfer unit 40 passes through a predetermined space when moving between the second inner position, where the image forming operation is performed, and the second outer position. The space through which the transfer unit 40 passes when moving from the second inner position to the second outer position will be referred to as a second space (a space for moving the transfer unit 40). The second space can also be referred to as a route or track (second moving route or second movement track) through which the transfer unit 40 passes when moving from the second inner position to the second outer position.

The position (usable position) of the fixing unit 80 when the image forming operation is performed has the following relationships with the first space and the second space.

As illustrated in FIGS. 6 and 7, at least a part of the fixing unit 80 located at the usable position overlaps the first space. In other words, in a state where the fixing unit 80 is located at the usable position, at least a part of the fixing unit 80 is inside the first space. As a result, the apparatus body 1A can be made smaller in size than in a configuration in which the fixing unit 80 located at the usable position is outside the first space.

In the present example, at least a part of the fixing unit 80 overlaps the space through which the cartridge P passes when the tray unit 50 moves from the first inner position to the first outer position, but may be disposed to overlap the space through which the tray 51 passes.

As illustrated in FIG. 6, in the present example, when the door 20 is in the closed state, at least a part of the duplex conveyance path 20a overlaps the first space. That is, when the door 20 is in the closed state, at least a part of the duplex conveyance path 20a is inside the first space.

As described above, at least a part of the fixing unit 80 located at the usable position is inside the first space. Therefore, in a state where the fixing unit 80 is located at the usable position, the tray unit 50 is restricted from moving from the first inner position to the first outer position. On the other hand, the fixing unit 80 is configured to be retractable from the usable position to the retracted position that is higher than the usable position. In a state where the fixing unit 80 is retracted from the usable position, the tray unit 50 is allowed to move from the first inner position to the first outer position. When the tray unit 50 moves from the first inner position to the first outer position, the tray unit 50 passes below the fixing unit 80.

Note that the fixing unit 80 is located outside the second space at the usable position and at the retracted position. Therefore, in both the state where the fixing unit 80 is located at the usable position and the state where the fixing unit 80 is located at the retracted position, the transfer unit 40 can move from the second inner position to the second outer position. When the transfer unit 40 moves from the second inner position to the second outer position, the transfer unit 40 passes below the fixing unit 80.

The fixing unit 80 includes a fixing frame body 80a that supports the fixing portion 81. When the fixing unit 80 is retracted from the usable position, the fixing frame body 80a is displaced with respect to apparatus body 1A while supporting the fixing portion 81.

When pulling out the tray unit 50 to the outside of the apparatus body 1A, the user first moves the door 20 to the opened position as illustrated in FIG. 2. In the present example, in a state where the fixing unit 80 is located at the usable position, the door 20 can move between the opened position and the closed position. Then, in a state where the door 20 is located at the opened position, the fixing unit 80 is moved from the usable position to the retracted position to retract the fixing unit 80 to the outside of the first space as illustrated in FIG. 3.

In the printer 1 of the present example, the fixing unit 80 is movable between the usable position and the retracted position retracted from the usable position in a state where it is attached to the apparatus body 1A. In the present example, when the fixing unit 80 is located at the retracted position, the entire fixing unit 80 is located outside the first space.

The fixing unit 80 is lifted from the usable position, and is located at the retracted position above the usable position. In other words, the retracted position is a position higher than the usable position. As illustrated in FIG. 7, when the fixing unit 80 is located at the retracted position, at least a part of the fixing unit 80 is located at a position protruding from the apparatus body 1A toward the outside of the apparatus body 1A. Further, when the fixing unit 80 is located at the retracted position, the position of at least a part of the fixing unit 80 is higher than the position of the upper cover portion 20b of the door 20 located at the closed position. As a result, it is possible to secure a space for the tray unit 50 to move by moving the fixing unit 80 to the retracted position, while maintaining the size of the printer 1 small when the fixing unit 80 is located at the usable position in the vertical direction Z. In a state where the fixing unit 80 is located at the retracted position, the door 20 is restricted from being located at the closed position.

Specifically, the printer 1 includes a coupling member (fixing link or arm) 85 movably coupled to the apparatus body 1A. The fixing unit 80 is coupled to the apparatus body 1A via the coupling member 85.

The coupling member 85 is rotatable about the rotation center 85A, and the coupling member 85 is moved to the outside of the first space when the tray unit 50 is pulled out to the outside of the apparatus body 1A. The fixing unit 80 is pivotably connected to one end of the coupling member 85, and the other end of the coupling member 85 is connected to the apparatus body 1A so as to be rotatable about the rotation center 85A. The fixing unit 80 is movable from the usable position to the retracted position and movable from the retracted position to the usable position in a state where it is supported by the coupling member 85 (in a state it is coupled to the apparatus body 1A via the coupling member 85). The coupling member 85 is configured to be movable (swingable) with respect to the apparatus body 1A and the fixing unit 80. That is, the fixing unit 80 is connected to the apparatus body 1A via the coupling member 85. As a result, the amount of movement of the fixing unit 80 when the fixing unit 80 moves between the retracted position and the usable position can be increased, as compared with a configuration in which the fixing unit 80 is directly connected to the apparatus body 1A.

As illustrated in FIG. 7, when the tray unit 50 moves from the first inner position to the first outer position, an angle formed by the moving direction of the tray unit 50 and the horizontal direction X is smaller than an angle formed by the moving direction of the tray unit 50 and the vertical direction Z. Furthermore, when the fixing unit 80 moves from the usable position to the retracted position, an amount of movement of the fixing unit 80 in the vertical direction Z is larger than an amount of movement of the fixing unit 80 in the horizontal direction X. In other words, when the fixing unit 80 moves from the usable position to the retracted position, an amount of movement of the fixing unit 80 in a direction perpendicular to the moving direction of the tray unit 50 is larger than an amount of movement of the fixing unit 80 in a direction parallel to the moving direction of the tray unit 50.

Furthermore, the fixing unit 80 may move between the usable position and the retracted position in a state where it is attached to the apparatus body 1A via a guide fixed to the apparatus body 1A. In this case, the guide has any shape.

The method for moving the fixing unit 80 to the outside of the first space is not limited to the example described above. For example, the fixing unit 80 may be removable from the apparatus body 1A to retract the fixing unit 80 from the usable position, so that the fixing unit 80 is moved to the outside of the first space. That is, the fixing unit 80 may be located outside the first space by separating the fixing unit 80 from the apparatus body 1A and the door 20 (separating the fixing unit 80 from the main frame 100). In addition, the fixing unit 80 may be coupled to the door 20, and the fixing unit 80 may be moved to the outside of the first space by opening the door 20.

### Moving Member

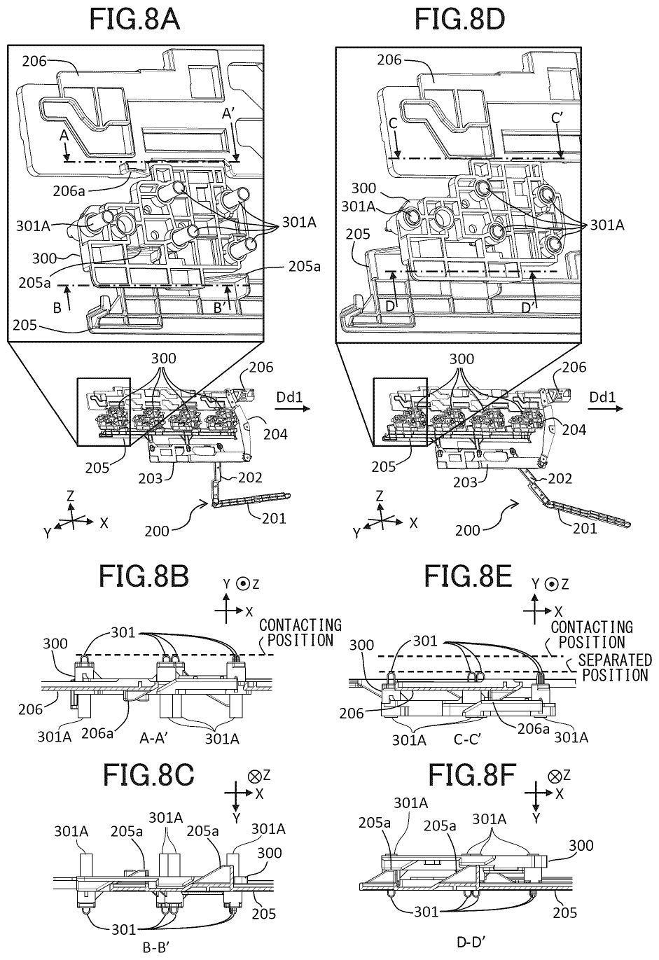

A moving member 300 and a link mechanism 200 that links the moving member 300 to the opening/closing of the door 20 will be described with reference to FIGS. 8A to 8F. Each of FIGS. 8A and 8D includes a perspective view and a partially enlarged view illustrating the moving member 300 and the link mechanism 200. FIG. 8B is a cross-sectional view illustrating the moving member 300 and the link mechanism 200 taken along line A-A′ in FIG. 8A. FIG. 8C is a cross-sectional view illustrating the moving member 300 and the link mechanism 200 taken along line B-B′ in FIG. 8A. FIG. 8E is a cross-sectional view illustrating the moving member 300 and the link mechanism 200 taken along line C-C′ in FIG. 8D. FIG. 8F is a cross-sectional view illustrating the moving member 300 and the link mechanism 200 taken along line D-D′ in FIG. 8D.

As illustrated in FIG. 8A, the printer 1 includes a moving member 300 and a link mechanism 200. The moving member 300 and the link mechanism 200 are disposed in the apparatus body 1A.

The apparatus body 1A may include a plurality of moving members 300 corresponding to the plurality of cartridges P attached to the tray 51, respectively. The apparatus body 1A of the present example includes four moving members 300 corresponding to the four cartridges P, respectively. That is, the apparatus body 1A of the present example includes a first moving member 300 corresponding to the yellow cartridge PY, a second moving member 300 corresponding to the magenta cartridge PM, a third moving member 300 corresponding to the cyan cartridge PC, and a fourth moving member 300 corresponding to the black cartridge PK. The ordinal numbers “first” to “fourth” are used for convenience, and do not indicate a specific order. In addition, the number of the moving members 300 may be smaller than the number of the plurality of cartridges P, and the moving members 300 may be arranged only for some of the cartridges P.

The four moving members 300 are arranged side by side in the tray detachment direction Dd1. That is, in the present example, the tray 51 and the cartridges PY to PK are moved from the first inner position (FIG. 3) toward the first outer position (FIG. 4) along a direction in which the plurality of moving members 300 are arranged.

The four moving members 300 have substantially the same configuration except that the cartridges P facing the four moving members 300 are different. Therefore, in the following description, when the “moving member 300” is simply referred to, any one of the four moving members 300 is indicated.

The moving member 300 is movable with respect to the apparatus body 1A between a first position (protruding position) illustrated in FIGS. 8A to 8C and a second position (retracted position) illustrated in FIGS. 8D to 8F. The moving member 300 is movable between the first position and the second position in a direction intersecting both the tray detachment direction Dd1 and the direction D2 in which the cartridge P is disengaged. The moving member 300 of the present example moves in the Y-axis direction, which is a direction orthogonal to both the tray detachment direction Dd1 and the disengagement direction D2.

The first position is a position of the moving member 300 when the door 20 is located at the closed position. The second position is a position of the moving member 300 when the door 20 is located at the opened position. In the present example, the second position is a position moved in the −Y direction from the first position. The second position can be said to be a position retracted from the first position toward a side (−Y side) away from an end surface in the Y-axis direction of the cartridge P attached to the apparatus body 1A together with the tray 51.

The moving member 300 of the present example has a role of moving a body-side contact 301 provided in the apparatus body 1A in conjunction with the opening/closing of the door 20. The moving member 300 can be referred to as a holder member that supports the body-side contact 301 and moves the body-side contact 301. The body-side contact 301 is a component (first contact, energization portion, power feeding portion) for electrically connecting an electric circuit of the apparatus body 1A and an electric circuit of the cartridge P. In the present example, the moving member 300 is engaged with the plurality of body-side contacts 301 to simultaneously move the plurality of body-side contacts 301.

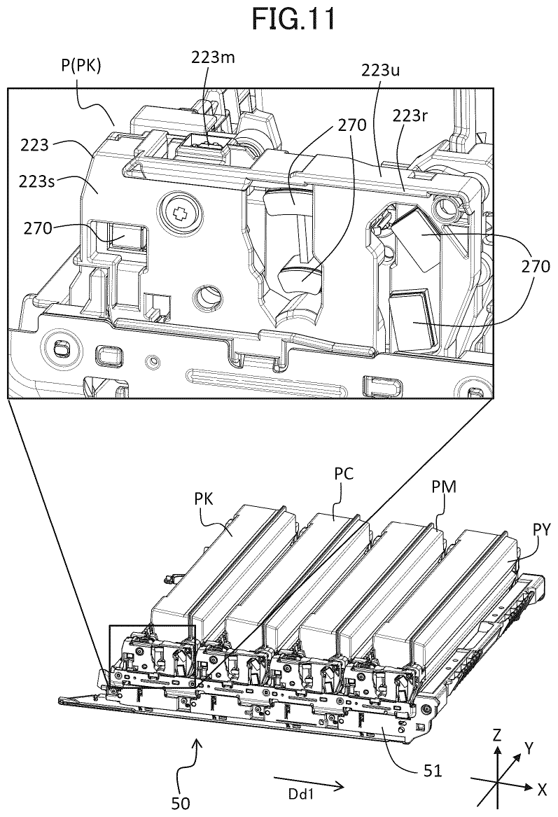

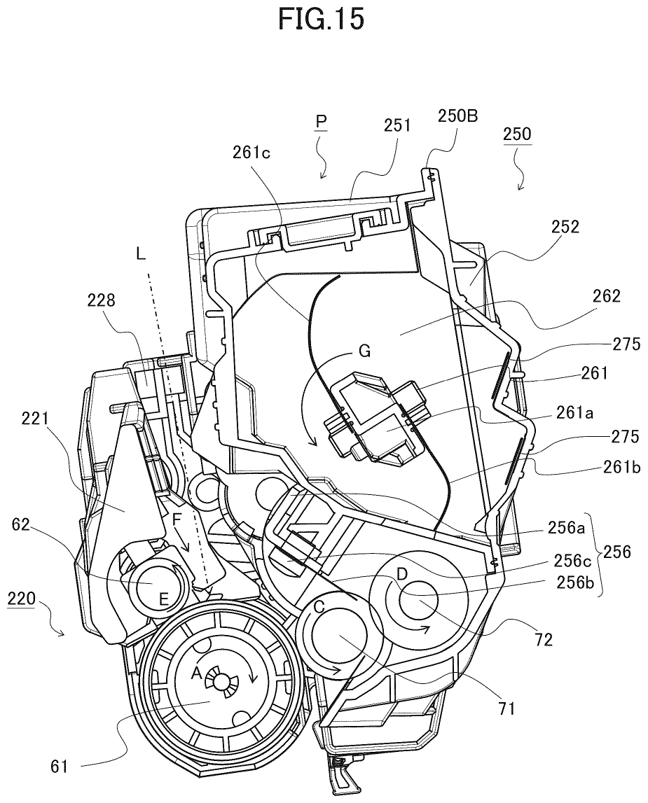

Each of the body-side contacts 301 is disposed at a position corresponding to a cartridge-side contact 270 (second contact, see FIG. 11) provided in the cartridge P. An example of the cartridge P including the cartridge-side contact 270 will be described below with reference to FIGS. 15 to 22. Each of the body-side contacts 301 is movable between a position (contact position) where it contacts the cartridge-side contact and a position (separated position) where it is separated from the cartridge-side contact. The separated position can be said to be a position retracted from the contact position toward the side (−Y side) away from the end surface in the Y-axis direction of the cartridge P attached to the apparatus body 1A together with the tray 51. More specifically, when the tray unit 50 is located at the first outer position, the cartridge-side contact 270 and the body-side contact 301 are separated from each other in the moving direction of the tray unit 50 as viewed in the Y-axis direction, and the cartridge-side contact 270 and the body-side contact 301 do not overlap each other. When the tray unit 50 is located at the first inner position, the cartridge-side contact 270 and the body-side contact 301 overlap each other as viewed in the Y-axis direction.

Each of the body-side contacts 301 in the present example is provided at an end of a contact spring 301A that is an elastic member elastically deformable (stretchable) in the Y-axis direction. The contact spring 301A may be a coil spring extending in the Y-axis direction. In addition, each of the body-side contacts 301 may be formed integrally with the contact spring 301A by bending up an end of a spring wire of the coil spring in a U shape. The contact spring 301A may constitute a part of an electrical conduction route for supplying power to the cartridge P via the body-side contact 301, or transmitting and receiving an electric signal to and from the cartridge P via the body-side contact 301.

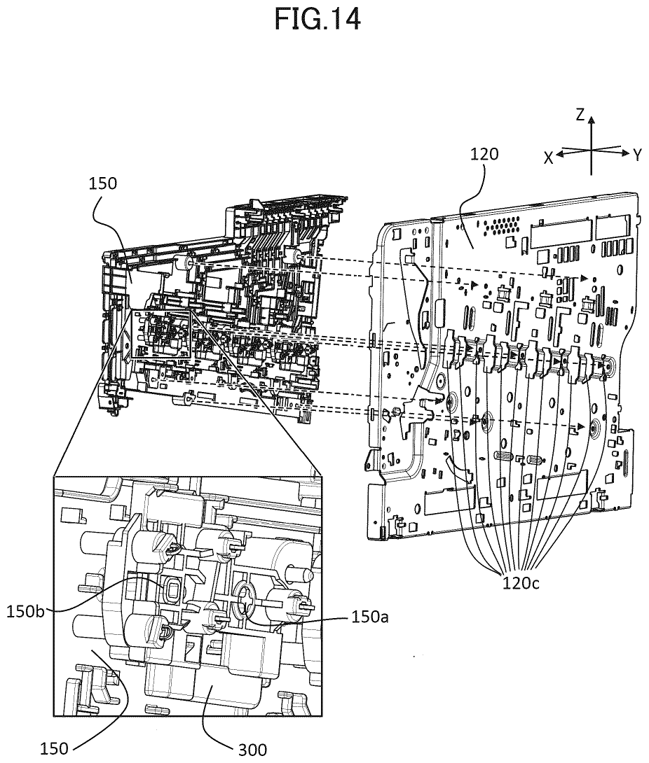

Each of the body-side contacts 301 is biased in the +Y direction, which is a direction from the separated position to the contact position, by a restoring force (resilient force) of the contact spring 301A. The position of the body-side contact 301 is determined by the moving member 300 abutting on an end surface in the +Y direction of the contact spring 301A. A through hole is formed in the moving member 300, and each of the body-side contacts 301 is exposed (protrudes) from the moving member 300 in the +Y direction through the through hole. The through hole is formed in a bottom portion of a contact holding portion 300a (see FIG. 14 as well) having a substantially bottomed cylindrical shape and holding an end on the +Y side of the contact spring 301A.

When the moving member 300 moves in conjunction with the opening/closing of the door 20 by the link mechanism 200 to be described below, each of the body-side contacts 301 moves between the contact position and the separated position. That is, the moving member 300 moves the body-side contact 301 (first contact) between the contact position, where the body-side contact 301 is in contact with the cartridge-side contact 270 (second contact), and the separated position, where the body-side contact 301 is separated from the cartridge-side contact 270. In the present example, one link mechanism 200 moves all the four moving members 300. While the tray unit 50 moves between the first inner position and the first outer position, the body-side contact 301 is located at the separated position because the door 20 is opened.

As illustrated in FIGS. 8A and 8D, the link mechanism 200 includes a first link 201, a second link 202, a third link 203, a fourth link 204, a fifth link 205, and a sixth link 206. Each of the links 201 to 206 is movably supported by the apparatus body 1A.

The first link 201 is coupled to the door 20, and moves in accordance with an opening/closing operation of the door 20. The second link 202 is coupled to the first link 201, and pivots about a predetermined rotation axis in accordance with a movement of the first link 201. The third link 203 is coupled to the second link 202, and moves in a direction along the X-axis direction in conjunction with the pivoting of the second link 202. The fourth link 204 is coupled to the third link 203 and pivots about a predetermined rotation axis in conjunction with the third link 203. The fifth link 205 is coupled to the third link 203, and reciprocates in the X-axis direction in conjunction with the pivoting of the third link 203. The sixth link 206 is coupled to the fourth link 204, and reciprocates in the X-axis direction in conjunction with the pivoting of the fourth link 204.

The fifth link 205 and the sixth link 206 both move in the X-axis direction, but move in opposite directions. That is, when the door 20 is moved from the closed position to the opened position (FIG. 8A→FIG. 8D), the fifth link 205 moves in the −X direction, and the sixth link 206 moves in the +X direction. When the door 20 is moved from the opened position to the closed position (FIG. 8D→FIG. 8A), the fifth link 205 moves in the +X direction, and the sixth link 206 moves in the −X direction.

The fifth link 205 and the sixth link 206 have cam surfaces 205a and 206a, respectively, which abut on the moving member 300. The cam surfaces 205a and 206a are surfaces facing the −Y direction, and are surfaces inclined in the +Y direction toward the moving directions of the fifth link 205 and the sixth link 206 when the door 20 is moved from the closed position to the opened position. That is, the cam surface 205a of the fifth link 205 is inclined in the +Y direction toward the −X direction, which is the moving direction of the fifth link 205 when the door 20 is moved from the closed position to the opened position. The cam surface 206a of the sixth link 206 is inclined in the +Y direction toward the +X direction, which is the moving direction of the sixth link 206 when the door 20 is moved from the closed position to the opened position.

When the door 20 is moved from the closed position to the opened position, the fifth link 205 and the sixth link 206 press the moving member 300 in the −Y direction by the cam surfaces 205a and 206a, and move the moving member 300 from the first position to the second position (FIG. 8A→FIG. 8D). As the moving member 300 moves from the first position to the second position, each of the body-side contacts 301 is moved in the −Y direction against the restoring force of the contact spring 301A (FIGS. 8B and 8C→FIGS. 8E and 8F). As a result, each of the body-side contacts 301 moves from the contact position to the separated position.

In this manner, in conjunction with the movement of the door 20 from the closed position to the opened position, the moving member 300 moves from the first position to the second position, and each of the body-side contacts 301 moves from the contact position to the separated position.

When the door 20 is closed, the moving directions of the members described above are reversed. That is, when the door 20 is moved from the opened position to the closed position, the fifth link 205 and the sixth link 206 release the pressing of the moving member 300 by the cam surfaces 205a and 206a. As a result, the moving member 300 moves in the +Y direction by the restoring force of the contact spring 301A, and moves from the second position to the first position (FIG. 8D→FIG. 8A). In addition, as the moving member 300 moves from the second position to the first position, each of the body-side contacts 301 is allowed to move in the +Y direction by the restoring force of the contact spring 301A (FIGS. 8E and 8F→FIGS. 8B and 8C). As a result, each of the body-side contacts 301 moves from the separated position to the contact position. In the present embodiment, the body-side contact 301 is configured to move directly (move linearly) between the contact position and the separated position.

According to the present example, the moving member 300 linearly moves in the Y-axis direction in conjunction with the opening/closing of the door 20. This configuration is suitable for moving the plurality of body-side contacts 301 between the contact position and the separated position using one moving member 300. However, the moving member 300 may pivot in conjunction with the opening/closing of the door 20. For example, in a case where one moving member 300 moves one body-side contact 301, the configuration of the link mechanism 200 may be simplified by using the pivoting moving member 300.

### Position of Moving Member

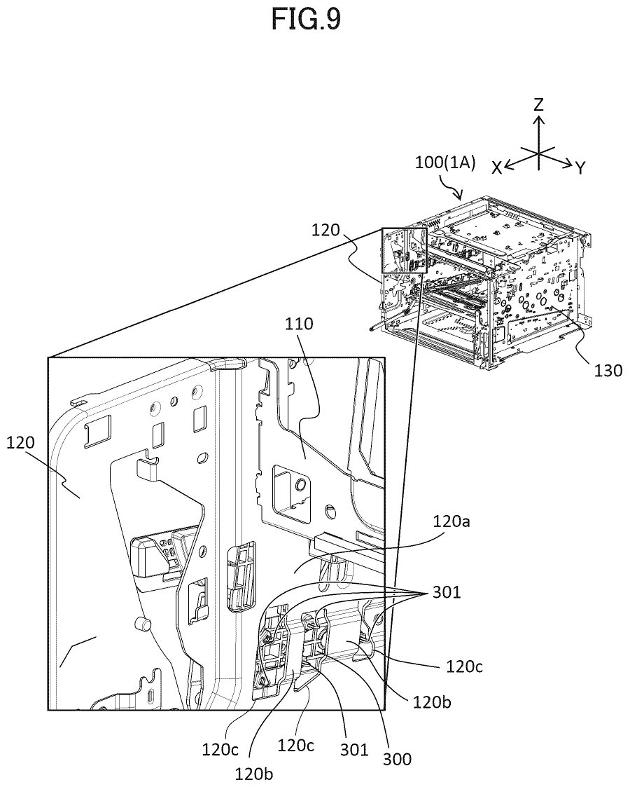

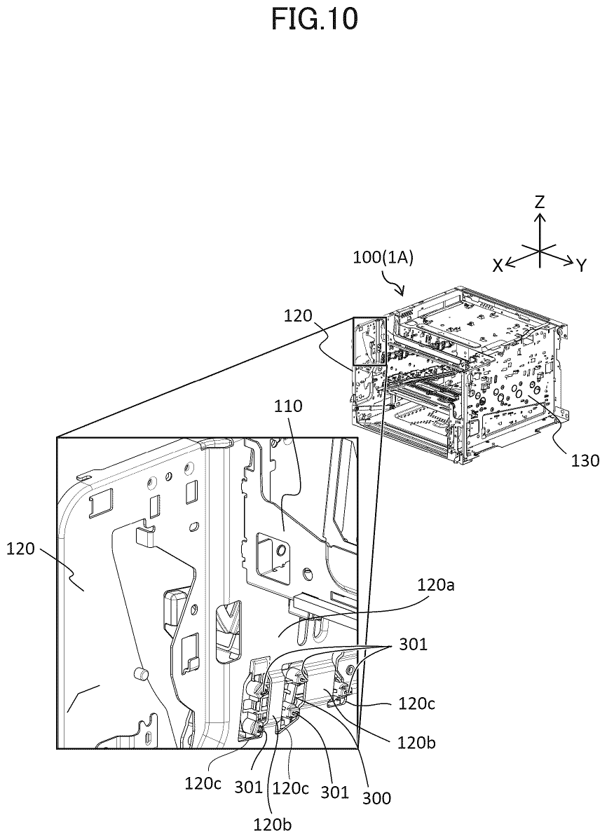

Next, the arrangement of the moving member 300 and the positional relationship of the moving member 300 with the cartridge P in the apparatus body 1A will be described with reference to FIGS. 9 and 10. Each of FIGS. 9 and 10 is a combination of a perspective view and a partially enlarged view of the apparatus body 1A excluding an exterior. FIG. 9 illustrates a state in which the moving member 300 is located at the second position and the body-side contact 301 is located at the separated position. FIG. 10 illustrates a state in which the moving member 300 is located at the first position and the body-side contact 301 is located at the contact position.

As illustrated in FIGS. 9 and 10, the apparatus body 1A includes a left side plate 120, a right side plate 130, and a main stay 110. The left side plate 120 is an example of a first side plate disposed on one side of the tray 51 in the Y-axis direction (third direction) with respect to a housing space (tray unit mounting space) in which the tray unit 50 inserted into the apparatus body 1A (casing) is housed. The right side plate 130 is an example of a second side plate disposed on the other side of the tray 51 in the Y-axis direction (third direction) with respect to the housing space.

The left side plate 120, the right side plate 130, and the main stay 110 are frame members made of metal (sheet metal) constituting a frame body of the printer 1. Each of the left side plate 120 and the right side plate 130 has a plate shape, expanding in a direction intersecting the Y-axis direction (preferably, an X −Z direction substantially orthogonal to the Y-axis direction). The main stay 110 extends along the Y-axis direction, and is fastened to both the left side plate 120 and the right side plate 130.

An opening portion 120c is formed in the left side plate 120. The opening portion 120c has a shape like a through hole or a cutout penetrating the left side plate 120 in the Y-axis direction. When viewed from the side of the housing space of the tray unit 50 (that is, from the +Y side with respect to the left side plate 120), the body-side contact 301 is exposed to the inside of the opening portion 120c.

In the present example, the number of body-side contacts 301 corresponding to one cartridge P is five in the apparatus body 1A. Three opening portions 120c are formed in the left side plate 120, and each of the five body-side contacts 301 is exposed to the inside of one of the three opening portions 120c. A plurality of opening portions 120c are formed in the left side plate 120 such that each of the body-side contacts 301 corresponding to the four cartridges PY to PK is exposed to the inside of one of the opening portions 120c. However, the number and arrangement of body-side contacts 301 corresponding to one cartridge P and the number and arrangement of body-side contacts 301 exposed to the inside of one opening portion 120c are not limited to the illustrated ones.

When the body-side contact 301 is located at the contact position (FIG. 10), the body-side contact 301 protrudes toward the housing space for the tray unit 50 with respect to the left side plate 120 through the opening portion 120c. That is, the body-side contact 301 located at the contact position protrudes toward the inside (+Y side) of the housing space with respect to the left side plate 120 forming a wall surface on the left side (−Y side) of the housing space for the tray unit 50. In addition, the body-side contact 301 located at the contact position protrudes inward of the housing space (toward the +Y side) beyond a protruding portion 120b of the left side plate 120 to be described below.

When the body-side contact 301 is located at the separated position (FIG. 9), the body-side contact 301 is retracted toward the −Y side relative to the contact position so as to be away from the housing space of the tray unit 50. When the body-side contact 301 is located at the separated position, the body-side contact 301 may be retracted outward of the housing space (to the −Y side) relative to the left side plate 120.

The positional relationship between the moving member 300 and the cartridge P during the operation from the time when the door 20 is opened to insert or pull out the tray unit 50 to the time when the door 20 is closed will be described.

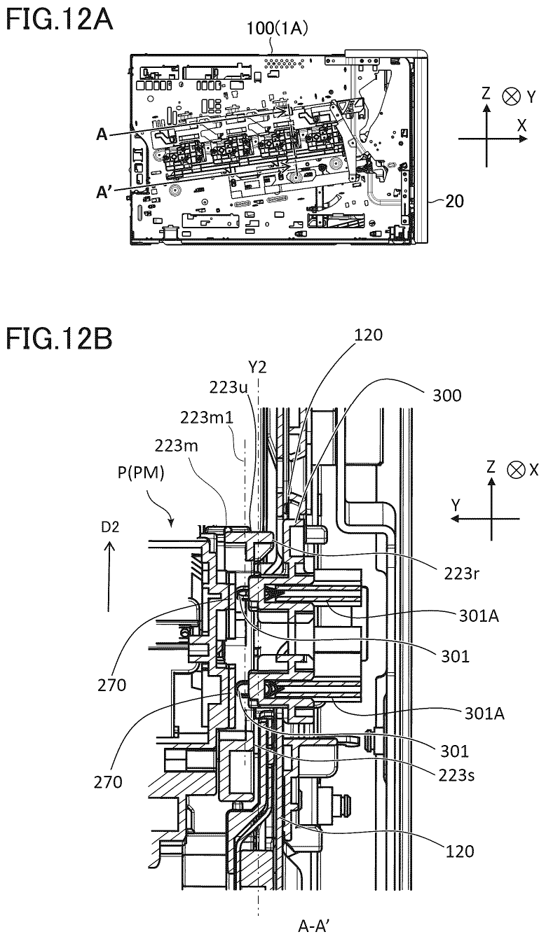

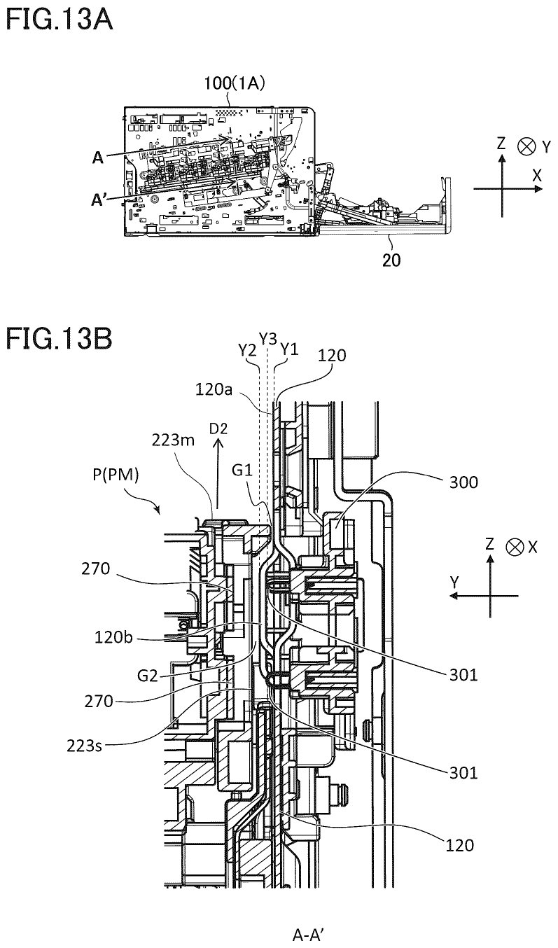

FIG. 12A is a schematic view of the printer 1 in a state where the door 20 is located at the closed position and the tray unit 50 is inserted into the first inner position of the apparatus body 1A. FIG. 12B is a cross-sectional view taken along line A-A′ in FIG. 12A. FIG. 13A is a schematic view of the printer 1 in a state where the door 20 is located at the opened position and the tray unit 50 remains inserted into the first inner position of the apparatus body 1A. FIG. 13B is a cross-sectional view taken along line A-A′ in FIG. 13A.

Note that FIGS. 12B and 13B illustrate a cross section passing through the magenta cartridge PM as an example of the cartridge P and the moving member 300 corresponding to the magenta cartridge PM. However, the configuration of the moving member 300 and the positional relationship between the moving member 300 and the cartridge PM when the tray unit 50 is located at the first inner position are the same for the other cartridges PY, PC, and PK.

When the door 20 is located at the closed position as illustrated in FIG. 12A, the moving member 300 is located at the first position as described above.

When the door 20 is moved from the closed position to the opened position as illustrated in FIG. 13A, the moving member 300 is moved from the first position to the second position in conjunction with the movement of the door 20 by the link mechanism 200 described above. As the moving member 300 moves from the first position to the second position, the body-side contact 301 moves from the contact position to the separated position.

After the door 20 is opened, the tray unit 50 is pulled out in the tray detachment direction Dd1 from the first inner position toward the first outer position. That is, in a state where the moving member 300 is located at the second position with the door 20 being located at the opened position, the tray unit 50 is pulled out from the apparatus body 1A. When the moving member 300 is located at the second position, the moving member 300 is retracted from the movement track for the cartridge PM when the tray unit 50 is pulled out from the apparatus body 1A. The movement track for the cartridge PM is a space (movement route) through which the cartridge PM passes when the tray unit 50 moves from the first inner position to the first outer position.

In addition, each of the moving members 300 corresponding to the cartridges PY to PK is also retracted from the movement track for any of the other cartridges P passing through the vicinity of the corresponding moving member 300 when the tray unit 50 is pulled out. That is, the second position of the moving member 300 is retracted from the movement tracks for all of the plurality of cartridges PY to PK when the tray 51 is pulled out from the inner position to the outer position. Therefore, it is possible to smoothly insert and pull out the tray unit 50 into and from the apparatus body 1A without the plurality of cartridges PY to PK interfering with the moving members 300.

In the present example, the configuration in which each moving member 300 is retracted from the first position to the second position in conjunction with the opening of the door 20 by the link mechanism 200 has been described, but the moving direction of the moving member 300 is not limited thereto. For example, after the door 20 is opened, a user may manually operate the moving member 300 to be retracted from the first position to the second position. In addition, for example, a driving source (motor, solenoid, or the like) for moving the moving member 300 may be arranged, and the driving source may retract the moving member 300 from the first position to the second position based on a command from the control unit 3.

### Support and Positioning of Moving Member

A configuration related to the support and positioning of the moving member 300 will be described with reference to FIG. 14. FIG. 14 is a combination of an assembled view of the left side plate 120 and a holder 150 and an enlarged view of a part of the holder 150.

As illustrated in FIG. 14, the holder 150 is attached to the left side plate 120. The holder 150 is a holding member (support member) that holds (supports) the moving member 300. For example, the holder 150 is screwed to the left side plate 120 at a plurality of positions, and is positioned and fixed to the left side plate 120. The holder 150 constitutes a part of apparatus body 1A together with the left side plate 120. That is, the main frame 100 of the printer 1 has the holder 150.

As described above, the opening portion 120c is formed in the left side plate 120. The first position of the moving member 300 is a position where the contact holding portion 300a, which is a part of the moving member 300, protrudes in the +Y direction with respect to the +Y side surface of the left side plate 120 through the opening portion 120c. That is, the opening portion 120c allows a part of the moving member 300 to protrude toward a space for mounting the tray unit 50 with respect to the left side plate 120.

The holder 150 has a boss 150a extending in the Y-axis direction. The moving member 300 has a boss hole 300b to be engaged with the boss 150a. By guiding the boss hole 300b to the boss 150a, the moving direction of the moving member 300 with respect to the apparatus body 1A including the holder 150 is restricted to the Y-axis direction. That is, the moving member 300 is supported by the apparatus body 1A in a state where the movement of the cartridge P in the disengagement direction D2 is restricted. The boss 150a is preferably formed to have a length equal to or longer than the moving distance of the moving member 300 between the contact position and the separated position so that the engagement between the boss 150a and the boss hole 300b is maintained while the moving member 300 moves from the contact position to the separated position.

In addition, the holder 150 includes a boss 150b disposed at a position away from the boss 150a as viewed in the Y-axis direction. By engaging the moving member 300 with the plurality of bosses 150a and 150b, the rotation of the moving member 300, for example, about the boss 150a is restricted. When the boss 150a is used as a positioning portion, the boss 150b can be referred to as a rotation-preventing engaging portion.

Each of the second link 202, the third link 203, the fourth link 204, the fifth link 205, and the sixth link 206 (FIGS. 8A to 8F) constituting the link mechanism 200 described above is also supported by the holder 150 so as to be movable in the above-described manner. That is, in the present example, the moving member 300 and at least a part of the link mechanism 200 that moves the moving member 300 are commonly supported by the holder 150. As a result, it is possible to suppress the influence of assembly tolerances of components and the like, and to accurately move the moving member 300 between the contact position and the separated position. In particular, the fifth link 205 and/or the sixth link 206 that moves the moving member 300 in direct contact with the moving member 300 is preferably supported by the holder 150 together with the moving member 300.

In addition, the holder 150 can hold an end on the −Y side of the contact spring 301A (an end opposite to the end held by the contact holding portion 300a of the moving member 300).

### Example of Configuration of Cartridge

An example of a configuration of the cartridge P will be described with reference to FIGS. 15 to 22. The cartridge P to be described below is an example of a cartridge P that can be attached to an apparatus body 1A including at least one body-side contact 301 (first contact), like the apparatus body 1A described with reference to FIGS. 1 to 14. The detailed configuration of the cartridge P can be changed depending on the specific configuration of the apparatus body 1A or the like. Therefore, it is not necessary that the configuration of the cartridge P illustrated in FIGS. 15 to 22 strictly match the configuration of the cartridge P illustrated in FIGS. 1 to 14. For example, the number, arrangement, and the like of cartridge-side contacts of the cartridge P to be described below may be corrected in accordance with the number and arrangement of body-side contacts 301 (first contacts) included in the apparatus body 1A.

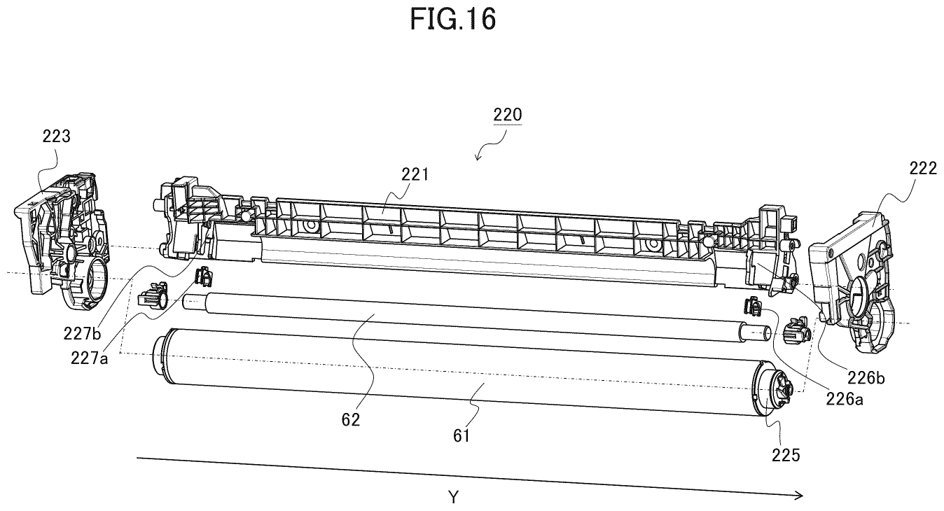

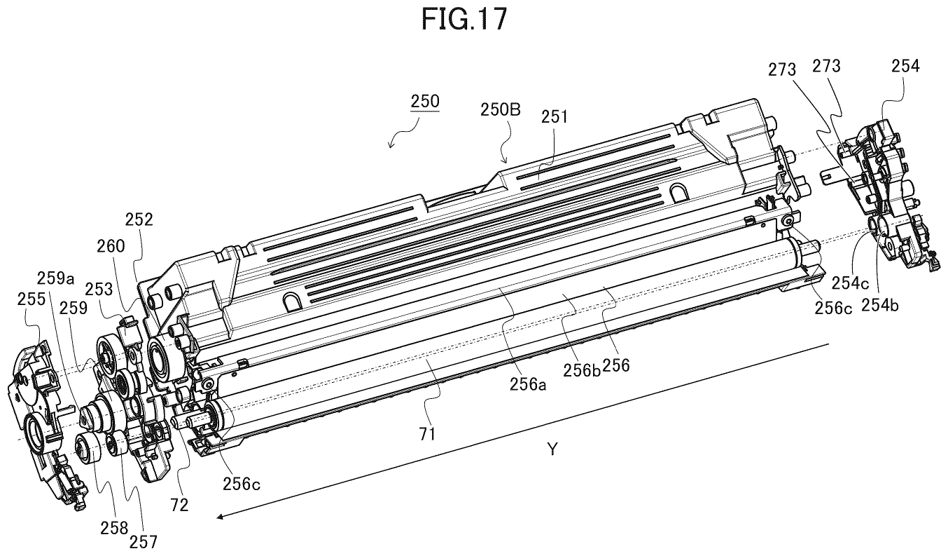

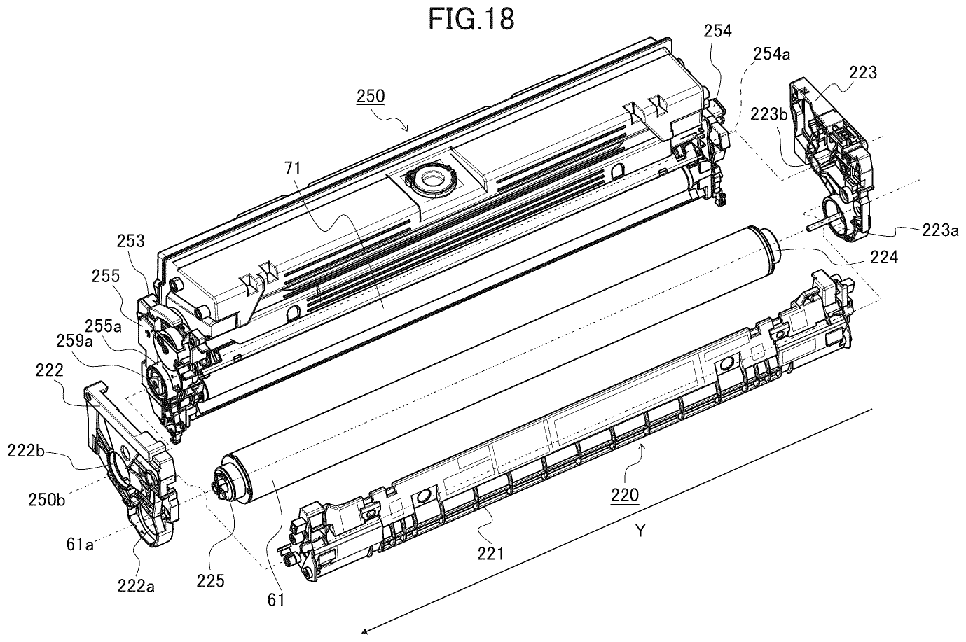

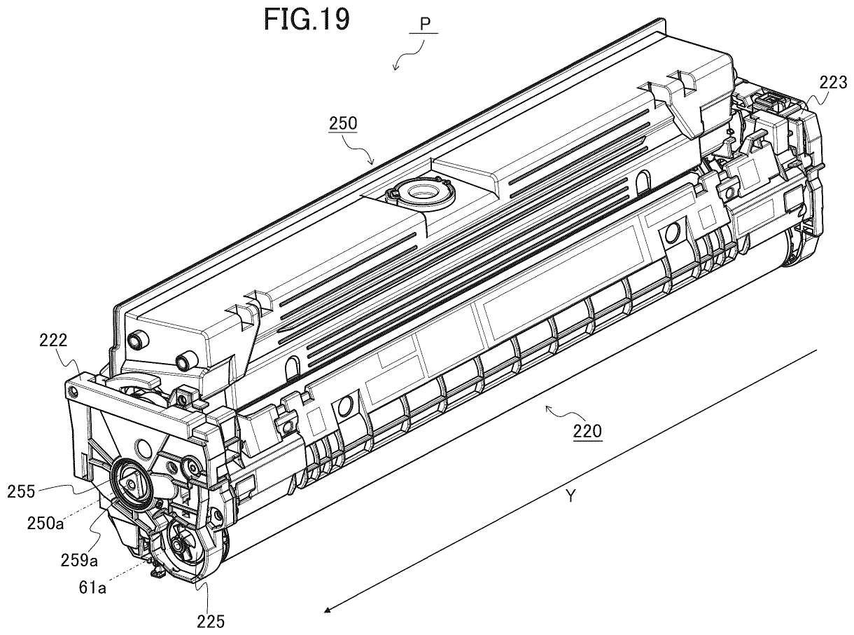

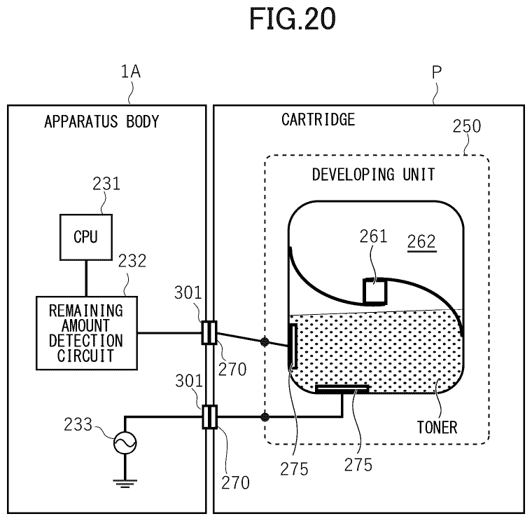

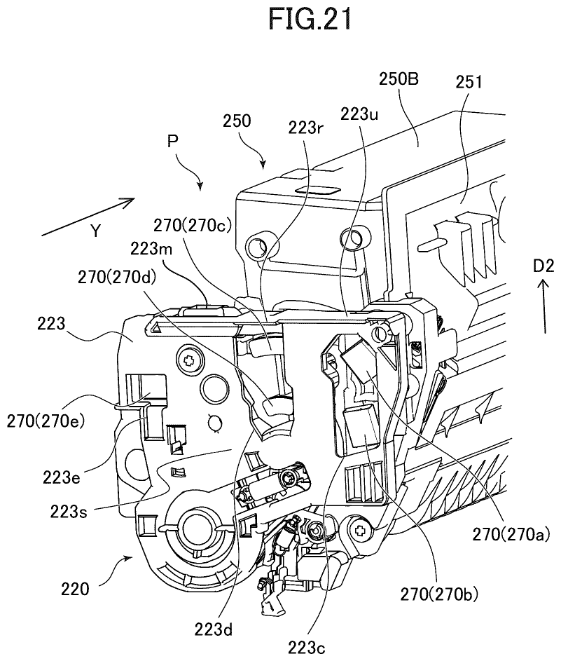

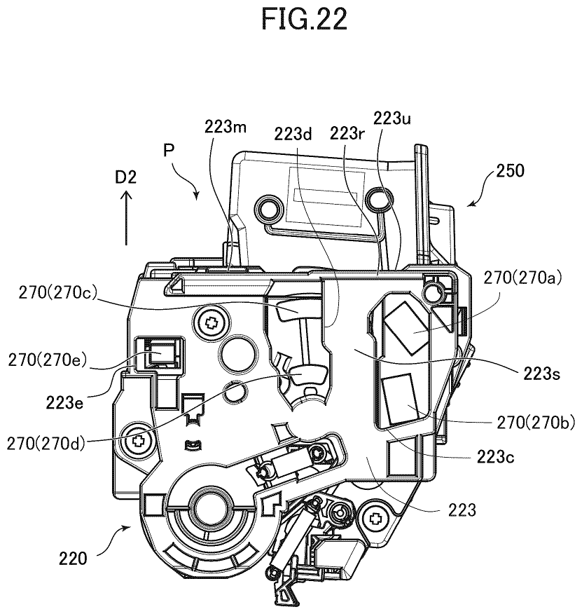

FIG. 15 is a cross-sectional view of a cartridge P. FIG. 16 is an exploded perspective view of a drum unit 220. FIG. 17 is an exploded perspective view of a developing unit 250. FIG. 18 is an assembled perspective view of the cartridge P. FIG. 19 is a perspective view of the cartridge P. FIG. 20 is a schematic view of a remaining toner amount detection mechanism in the printer 1. FIG. 21 is a perspective view of an end on a non-drive side of the cartridge P. FIG. 22 is a side view of the cartridge Pas viewed from the non-drive side.

As illustrated in FIG. 15, the cartridge P mainly includes a drum unit 220 and a developing unit 250. The drum unit 220 includes a photosensitive drum 61 and a charging roller 62. The developing unit 250 includes a developing roller 71. A cleaning blade serving as a cleaning unit may be disposed in the drum unit 220. The drum unit 220 and the developing unit 250 are coupled so as to be movable relative to each other. A space L through which light from the scanner 2 (FIG. 1) passes is formed between the drum unit 220 and the developing unit 250. The developing unit 250 includes a developing frame body 250B, which is a frame body of the developing unit 250. A container space for containing a toner is formed inside the developing frame body 250B.

Each of the cartridge P, the drum unit 220, and the developing unit 250 has an outer shape elongated in the Y-axis direction. Therefore, the Y-axis direction can be referred to as a longitudinal direction of the cartridge P, the drum unit 220, and the developing unit 250.

In addition, the cartridge P is configured such that the drive side is input from the apparatus body 1A to the end on the +Y side. Therefore, the +Y side (right side) may be referred to as the drive side, and the −Y side (left side) may be referred to as the non-drive side.

### Drum Unit

As illustrated in FIGS. 16 and 18, the drum unit 220 includes a photosensitive drum 61, a charging roller 62, a drum frame body 221, bearings 226a and 227a, pressure springs 226b and 227b, a drive side cover 222, and a non-drive side cover 223.

An end on the drive side of the photosensitive drum 61 is engaged with a drum support hole 222a of the drive side cover 222, and an end on the non-drive side of the photosensitive drum 61 is engaged with a drum support hole 223a of the non-drive side cover 223 (FIG. 18). The photosensitive drum 61 is supported so as to be rotatable around a rotation axis 61a by the drive side cover 222 and the non-drive side cover 223.

A drum coupling 225 is formed at the end on the drive side of the photosensitive drum 61 as an input member to which the driving force of the motor arranged in the apparatus body 1A is input. Four body couplings are provided in the apparatus body 1A as output members from which the driving force of the motor is output. The body couplings are arranged to be engaged with the drum couplings 225 of the respective cartridges P in a state where the cartridges PY to PK are located at the image forming positions. When the driving force is transmitted through the body coupling and the drum coupling 225, the photosensitive drum 61 is driven to rotate in a predetermined direction (a direction indicated by arrow A in FIG. 15).

The charging roller 62 is rotatably supported by the bearings 226a and 227a supported by the drum frame body 221. In addition, the bearings 226a and 227a are pressed by the pressure springs 226b and 227b, whereby the charging roller 62 is biased toward the photosensitive drum 61 (in a direction indicated by arrow F in FIG. 15). The charging roller 62 rotates following the photosensitive drum 61 (a direction indicated by arrow E in FIG. 15). In the Y-axis direction, an end on the drive side of the drum frame body 221 is connected to the drive side cover 222, and an end on the non-drive side of the drum frame body 221 is connected to the non-drive side cover 223.

### Developing Unit

As illustrated in FIGS. 15 and 17, the developing unit 250 includes a developing frame body 250B, a developing roller 71, a supplying roller 72, a developing blade 256, a stirring member 261, and a drive train (257, 258, 259).

The developing frame body 250B includes a first frame 251, a second frame 252, a drive side bearing 253, a non-drive side bearing 254, and a drive side cover 255. The first frame 251 and the second frame 252 form a toner container 262 (FIG. 15) as a container space for containing a toner. An edge portion of the first frame 251 and an edge portion of the second frame 252 are joined to each other, for example, by ultrasonic welding or using a hot melt adhesive.

The first frame 251 and the second frame 252 are frame members forming a container (developer container) in which the toner container 262 is formed. The drive side bearing 253 is attached to one end side (drive side) of the developer container in the Y-axis direction, and the non-drive side bearing 254 is attached to the other end side (non-drive side) of the developer container in the Y-axis direction. The drive side bearing 253 and the non-drive side bearing 254 are fixed to the first frame 251 and the second frame 252, for example, by a screw fastening method.

The drive side cover 255 is disposed outside (farther on the drive side than) the drive side bearing 253 in the Y-axis direction. The drive side cover 255 is fixed (fastened together) to the first frame 251 and the second frame 252 together with the drive side bearing 253, for example, by a screw fastening method. In the present embodiment, the developing frame body 250B serving as a frame body of the developing unit 250 is formed as a structure in which the first frame 251, the second frame 252, the drive side bearing 253, the non-drive side bearing 254, and the drive side cover 255 are integrated.

Both ends of the developing roller 71 in the Y-axis direction are rotatably supported by the drive side bearing 253 and the non-drive side bearing 254 serving as bearing members. An end of the supplying roller 72 in the Y-axis direction is rotatably supported by the drive side bearing 253 and the non-drive side bearing 254.

The developing blade 256 includes an elastic member 256b serving as a blade body, and a support member 256a supporting the elastic member 256b. The elastic member 256b is, for example, a sheet-like metal having a thickness of about 0.1 mm. The support member 256a is, for example, a highly rigid metal member having an L-shaped cross section. The elastic member 256b is fixed to the support member 256a by welding or the like. In addition, both ends of the support member 256a in the Y-axis direction are fixed to the developing frame body 250B (first frame 251), for example, using screws 256c.

The stirring member 261 includes a rotation shaft 261a extending substantially parallel to the rotation axis of the developing roller 71, and stirring sheets 261b and 261c formed of a flexible sheet material. One ends (fixed ends) of the stirring sheets 261b and 261c are attached to the rotation shaft 261a, and the other ends of the stirring sheets 261b and 261c are free ends. The stirring member 261 is configured to stir the toner in the toner container 262 as the stirring sheets 261b and 261c rotate around the rotation shaft 261a in accordance with the rotation of the rotation shaft 261a. In addition, in accordance with the rotation of the rotation shaft 261a, the toner is conveyed toward the developing roller 71 and the supplying roller 72 by the stirring sheets 261b and 261c serving as conveying units that convey the toner.

A drive transmission configuration in the developing unit 250 will be described. The drive train described above includes an input gear 259, a developing roller gear 257, a supplying roller gear 258, and a stirring gear 260, and is disposed at an end on the drive side of the developing unit 250 (FIG. 19). At least a part of the drive train is housed in a space formed between the drive side bearing 253 and the drive side cover 255.

The developing roller gear 257, the supplying roller gear 258, and the stirring gear 260 are directly or indirectly connected to the input gear 259, and are configured to rotate in conjunction with the rotation of the input gear 259. The developing roller gear 257 is provided at an end on the drive side of the developing roller 71. The supplying roller gear 258 is provided at an end on the drive side of the supplying roller 72. The stirring gear 260 is provided at an end on the drive side of the stirring member 261.

The input gear 259 has a development coupling 259a. The input gear 259 functions as an input member to which the driving force of the motor disposed in the apparatus body 1A is input. Four development body couplings are provided in the apparatus body 1A as output members from which the driving force of the motor is output. The development body couplings are disposed to be engaged with the development couplings 259a of the respective process cartridges in a state where the cartridges PY to PK are located at the image forming positions. When the driving force is transmitted through the development body coupling and the development coupling 259a, the developing roller 71, the supplying roller 72, and the stirring member 261 are driven to rotate in predetermined directions, respectively (directions indicated by arrows C, D, and G in FIG. 15).

### Method of Assembling Cartridge

A method of assembling the cartridge P will be described with reference to FIGS. 18 and 19. As illustrated in FIG. 19, the drive side cover 222 and the non-drive side cover 223 has developing unit support holes 222b and 223b for swingably (movably) supporting the developing unit 250. On the other hand, the drive side cover 255 of the developing unit 250 has a cylindrical portion 255a to be engaged with the developing unit support hole 222b. The non-drive side bearing 254 of the developing unit 250 also has a cylindrical portion 254a to be engaged with the developing unit support hole 223b. That is, the cylindrical portions 254a and 255a serving as engaging portions are provided in the developing frame body 250B of the developing unit 250.

When assembling the cartridge P, the cylindrical portions 254a and 255a of the developing frame body 250B are engaged with the developing unit support holes 222b and 223b of the drive side cover 222 and the non-drive side cover 223, respectively. At the same time, both ends of the photosensitive drum 61 are engaged with the drum support holes 222a and 223a of the drive side cover 222 and the non-drive side cover 223. Then, the drive side cover 222 and the non-drive side cover 223 are fixed to the drum frame body 221 using screws, an adhesive, or the like.

As a result, the cartridge P is assembled in a state where the developing unit 250 is swingable with respect to the drum unit 220 (FIG. 19). When the developing unit 250 swings with respect to the drum unit 220 around an axis 250a, the developing roller 71 is allowed to move to approach and be separated from the photosensitive drum 61. For example, the developing roller 71 is held at a position where it contacts the photosensitive drum 61 or at a position facing the photosensitive drum 61 with a predetermined gap therebetween when an image is formed, and is held at a position separated from the photosensitive drum 61 when an image is not formed (in a period during which the image forming operation is not executed).

The axis 250a of the developing unit 250 is a virtual straight line connecting the center of the developing unit support hole 222b of the drive side cover 222 and the center of the developing unit support hole 223b of the non-drive side cover 223. The axis 250a is substantially the same as the rotation axis of the development coupling 259a of the developing unit 250. That is, the driving force is transmitted from the apparatus body 1A to the developing unit 250 through the input member disposed coaxially with the axis 250a of the developing unit 250.

It has been described above that the drum unit 220 including the drive side cover 222 and the non-drive side cover 223 is coupled to the developing unit 250. On the other hand, it can also be considered that the developing unit is coupled to the drum unit including the photosensitive drum 61, the charging roller 62, and the drum frame body 221 by the drive side cover 222 and the non-drive side cover 223 serving as cover members for all the process cartridges.

### Route for Supplying Power to Electric Components

Next, a configuration of a route for supplying power to electric components included in the cartridge P will be described. The electric components are components that perform their functions by being electrically connected to the electric circuit of the apparatus body 1A. The electric components in the present example include a charging roller 62, a developing roller 71, a developing blade 256, and an electrode sheet 275 (FIG. 15). The charging roller 62, the developing roller 71, the developing blade 256, and the electrode sheet 275 are electrically connected to the electric circuit of the apparatus body 1A via the body-side contact 301 (first contact) and the cartridge-side contact 270 (second contact). Some of these electric components may not be included in the cartridge P, and another electric component may be included in the cartridge P. Another electric component is, for example, a storage medium (memory tag) that stores information about the cartridge P.

As illustrated in FIGS. 21 and 22, the cartridge P has at least one cartridge-side contact 270 connected to the body-side contact 301. Each cartridge-side contact 270 is a member (second contact) for electrically connecting the cartridge P and the apparatus body 1A by contact with the body-side contact 301 (first contact). In the present example, the cartridge P includes a first contact 270a, a second contact 270b, a third contact 270c, a fourth contact 270d, and a fifth contact 270e as the plurality of cartridge-side contacts 270.

The cartridge-side contacts 270 are disposed at an end on the non-drive side of the cartridge P. More specifically, the first contact 270a is disposed on an end surface on the non-drive side (−Y side) of the drum frame body 221 (FIG. 16). The second contact 270b, the third contact 270c, the fourth contact 270d, and the fifth contact 270e are arranged on an end surface on the non-drive side (−Y side) of the non-drive side bearing 254 (FIG. 17) of the developing unit 250.

The non-drive side cover 223 of the cartridge P has opening windows 223c, 223d, and 223e (FIG. 21) that are opening portions penetrating the non-drive side cover 223 in the Y-axis direction. When the cartridge P is viewed in the Y-axis direction from the non-drive side, at least a part of the first contact 270a is exposed through the opening window 223c, and at least a part of the second contact 270b and at least a part of the third contact 270c are exposed through the opening window 223d (FIG. 22). In addition, when the cartridge P is viewed in the Y-axis direction from the non-drive side, at least a part of the fourth contact 270d and at least a part of the fifth contact 270e are exposed through the opening window 223e.

Each of the contacts (270a to 270e) may be made of only a conductive resin constituting a part of the drum frame body 221 or a part of the non-drive side bearing 254, or may be a conductive member such as metal fixed to the drum frame body 221 or the non-drive side bearing 254.

The first contact 270a is electrically connected to one of the electrode sheets 275 (FIG. 15), and can contact one (first body-side contact) of the body-side contacts 301 in a state where the cartridge P is attached to the apparatus body 1A. The second contact 270b is electrically connected to another one of the electrode sheets 275, and can contact another one (second body-side contact) of the body-side contacts 301 of the apparatus body 1A in a state where the cartridge P is attached to the apparatus body 1A. The third contact 270c is electrically connected to the developing roller 71, and can contact another one (third body-side contact) of the body-side contacts 301 in a state where the cartridge P is attached to the apparatus body 1A. The fourth contact 270d is electrically connected to the developing blade 256, and can contact another one (fourth body-side contact) of the body-side contacts 301 in a state where the cartridge P is attached to the apparatus body 1A. The fifth contact 270e is electrically connected to the charging roller 62, and can contact another one (fifth body-side contact) of the body-side contacts 301 in a state where the cartridge P is attached to the apparatus body 1A.

The first contact 270a and the second contact 270b constitute a part of the remaining toner amount detection mechanism to be described below. The developing roller 71 is electrically connected to a high-voltage substrate of the apparatus body 1A via the third contact 270c and the body-side contact 301 (third body-side contact), and a developing voltage is applied to the developing roller 71 from the high-voltage substrate. The developing blade 256 is electrically connected to the high-voltage substrate of the apparatus body 1A via the fourth contact 270d and the body-side contact 301 (fourth body-side contact), and a bias voltage (blade voltage) for increasing the toner charging amount is applied to the developing blade 256 from the high-voltage substrate. The charging roller 62 is electrically connected to the high-voltage substrate of the apparatus body 1A via the fifth contact 270e and the body-side contact 301 (fifth body-side contact), and a charging voltage is applied to the charging roller 62 from the high-voltage substrate.

### Remaining Toner Amount Detection Mechanism

The printer 1 includes a remaining toner amount detection mechanism for detecting an amount of toner (hereinafter, referred to as a remaining toner amount) contained in the developing unit 250 (in the cartridge P). FIG. 20 is a schematic view illustrating an example of a remaining toner amount detection mechanism.

The remaining toner amount detection mechanism includes a CPU 231, a remaining amount detection circuit 232, a voltage application unit 233, and two body-side contacts 301, which is disposed in the apparatus body 1A. In addition, the remaining toner amount detection mechanism includes a first contact 270a, a second contact 270b, and two electrode sheets 275, each of which is disposed in the cartridge P.

One electrode sheet 275 is electrically connected to the voltage application unit 233 of the apparatus body 1A via the first contact 270a and the body-side contact 301 (first body-side contact). The other electrode sheet 275 is electrically connected to the remaining amount detection circuit 232 of the apparatus body 1A via the second contact 270b and the body-side contact 301 (second body-side contact). The CPU 231 is electrically connected to the remaining amount detection circuit 232. The CPU 231 and the remaining amount detection circuit 232 may be a part of a control unit (control board) attached to the apparatus body 1A.

Each electrode sheet 275 is exposed to the toner container 262 inside the developing frame body 250B. Hereinafter, the electrode sheet 275 to which the voltage is applied from the voltage application unit 233 will be referred to as the input-side electrode sheet 275, and the electrode sheet 275 electrically connected to the remaining amount detection circuit 232 will be referred to as the output-side electrode sheet 275.

The remaining toner amount detection mechanism according to the present embodiment is a capacitance-type detection mechanism that detects a remaining toner amount based on a detection result for a capacitance between the two electrode sheets 275 that are electrode members. The CPU 231 applies an AC voltage to the input-side electrode sheet 275 (first electrode) by the voltage application unit 233, thereby inducing a capacitance between the electrode sheets 275. The magnitude of the capacitance between the electrode sheets 275 changes depending on the amount of the dielectric present between the electrode sheets 275, that is, the amount of toner.

The remaining amount detection circuit 232 outputs a detection signal corresponding to the capacitance between the electrode sheets 275. As a specific example, the remaining amount detection circuit 232 obtains a reference voltage by applying the same AC voltage as that applied to the input-side electrode sheet 275 to a reference capacitive element having a known capacitance. In addition, the remaining amount detection circuit 232 compares a voltage value of the output-side electrode sheet 275 (second electrode) with the reference voltage, and outputs a difference therebetween, which is a voltage value as a detection signal.

The CPU 231 executes control based on the remaining toner amount based on the detection signal from the remaining amount detection circuit 232. For example, when the remaining toner amount is smaller than a preset threshold, the CPU 231 notifies the user of information for prompting the user to replace the cartridge P (cartridge replacement information). The notification method may be a screen display on an operation panel included in the printer 1 or notification to an external information processing terminal communicably connected to the printer 1.

The remaining toner amount detection mechanism described above is merely an example of a remaining amount detection mechanism that detects an amount of a developer contained in the container (toner container 262) inside the cartridge P. The remaining amount detection mechanism is not limited to the capacitance-type detection mechanism described in the present example, and may be, for example, an optical detection-type detection mechanism. In optical detection-type detection mechanism, light emitted from a light emitting element is incident on a light receiving element via a spatial optical path passing through the inside of the toner container 262, and a remaining toner amount is detected based on a detection signal from the light receiving element using a change in a time length or the like for which light is blocked depending on the remaining toner amount. Shape of End of Cartridge

The shape of the end on the −Y side (non-drive side or left side) of the cartridge P and the position of the cartridge-side contact 270 will be described with reference to FIGS. 21 and 22.

As illustrated in FIGS. 21 and 22, at least a part of an end surface on the −Y side of the cartridge P in the present example is formed by the non-drive side cover 223. The non-drive side cover 223 has a side surface portion 223s that is a surface facing the −Y side, and a rib shape 223r protruding to the −Y side with respect to the side surface portion 223s.

In a case where a direction from the left side plate 120 toward the right side plate 130 (that is, the +Y direction) is defined as a first direction, the side surface portion 223s is an example of a second surface facing the upstream side in the first direction, and the rib shape 223r is an example of a second protruding portion protruding to the upstream side in the first direction with respect to the second surface. An end surface (a surface forming a ridge line) on the −Y side of the rib shape 223r is a surface protruding to the upstream side (−Y side) in the first direction relative to the second surface. Note that the first direction (+Y direction) in the present example is substantially parallel to the rotation axis direction of the photosensitive drum 61 included in the cartridge P.

The upstream side in the first direction refers to an opposite direction opposite to the first direction (the direction from the right side plate 130 toward the left side plate 120, that is, the −Y direction, in the present example). The side surface portion 223s is an example of a second surface facing the first direction, and the rib shape 223r is an example of a second protruding portion protruding in the opposite direction opposite to the first direction with respect to the second surface. An end surface on the −Y side of the rib shape 223r is a surface protruding in the opposite direction opposite to the first direction relative to the second surface.

At least a part of the side surface portion 223s is a surface extending in a direction intersecting the Y-axis direction (preferably, a direction substantially orthogonal to the Y-axis direction). The above-described opening windows 223c, 223d, and 223e through which the cartridge-side contacts 270 are exposed are mainly formed in the side surface portion 223s. However, the opening edge on the upper side (+Z side) of the opening window 223d is formed by the rib shape 223r.

When viewed in the Y-axis direction, the side surface portion 223s has a larger area than the rib shape 223r. The “side surface portion 223s” in the present example refers to a portion obtained by removing the rib shape 223r and the opening windows 223c, 223d, and 223e from the end surface on the −Y side of the non-drive side cover 223.

In the present example, the rib shape 223r is formed in an upper portion of the side surface portion 223s and extends substantially along the X-axis direction. That is, the rib shape 223r extends in a direction along the moving direction of the tray unit 50. The rib shape 223r may be disposed at an end on the upper side (+Z side) of the non-drive side cover 223.

By providing the rib shape 223r, the strength (stiffness) of the non-drive side cover 223 can be enhanced.

A storage medium 223m (memory tag) that stores information about the cartridge P can be attached to an end surface 223u on the upper side (+Z side) of the non-drive side cover 223 (FIGS. 21 and 22). The apparatus body 1 A includes a tag connector that contacts a contact exposed on the upper surface of the storage medium 223m in a state where the tray unit 50 is inserted into the apparatus body 1A. By electrically conducting the tag connector of the apparatus body 1A to the contact of the storage medium 223m, the control unit 3 of the printer 1 can read information from the storage medium 223m. The information stored in the storage medium 223m is, for example, identification information (production lot or the like) of the cartridge P, the color of the toner, or the toner-filled amount.

By disposing the storage medium 223m on the non-drive side cover 223 forming the end surface on the −Y side of the cartridge P, the tag connector of the apparatus body 1A can be disposed near the left side plate 120. Therefore, for example, as compared with a configuration in which the storage medium 223m is disposed on the +Y side (closer to the center of the cartridge P) with respect to the non-drive side cover 223, the length of the harness connecting the tag connector and the control unit 3 can be shortened.

As illustrated in FIG. 12B, the position at which the body-side contact 301 comes into contact with the cartridge-side contact 270 may be on the +Y side (cartridge P side) with respect to an end position 223m1 on the −Y side (left side plate 120 side) of the storage medium 223m. That is, the position where the body-side contact 301 (first contact) and the cartridge-side contact 270 (second contact) contact each other may be downstream in the +Y direction with respect to the end position 223m1 on the upstream side in the +Y direction (i.e., upstream end position in first direction) of the storage medium 223m (an end position of the storage medium 223m in the opposite direction opposite to the first direction). The cartridge-side contact 270 has a contact surface extending in a direction intersecting the +Y direction (preferably, a direction orthogonal to the +Y direction), and the body-side contact 301 abuts on the contact surface.

### Positional Relationship between Body-Side Contact and Left Side Plate

Next, the positional relationship between the contact position and the separated position of the body-side contact 301 and the shape of the left side plate 120 will be described.

As illustrated in FIGS. 9 and 10, the left side plate 120 includes a reference surface 120a and a protruding portion 120b protruding in the +Y direction with respect to the reference surface 120a. In a case where a direction from the left side plate 120 toward the right side plate 130 (that is, the +Y direction) is a first direction, the reference surface 120a is an example of a first surface facing the downstream side in the first direction, and the protruding portion 120b is an example of a first protruding portion protruding downstream in the first direction relative to the first surface.

The reference surface 120a is a surface facing the +Y direction (a surface facing the housing space for the tray unit 50) of the left side plate 120. The reference surface 120a and the protruding portion 120b are integrally formed by bending or drawing of a sheet metal.

An end in the −Y direction of the main stay 110 described above is connected to the reference surface 120a of the left side plate 120. An end in the +Y direction of the main stay 110 is connected to a reference surface of the right side plate 130. The distance between the reference surface 120a of the left side plate 120 and the reference surface of the right side plate 130 is determined according to the width in the Y-axis direction required for the housing space for the tray unit 50 (e.g., the lengths of the cartridge P and the transfer unit 40 in the main scanning direction when an image is formed).

In a state where the tray unit 50 is inserted into the apparatus body 1A, the protruding portion 120b of the left side plate 120 faces the side surface portion 223s of the cartridge P, and the rib shape 223r of the cartridge P faces the reference surface 120a of the left side plate 120. That is, in a state where the cartridge is attached to the casing, the first protruding portion (protruding portion 120b) of the first side plate faces the second surface (side surface portion 223s) of the cartridge, and the second protruding portion (rib shape 223r) of the cartridge faces the first surface (reference surface 120a) of the first side plate.

In the present example, the left side plate 120 has a plurality of protruding portions 120b arranged in the tray detachment direction Dd1. The opening portion 120c of the left side plate 120 may be formed between the adjacent protruding portions 120b. In addition, the at least one body-side contact 301 may be disposed between the protruding portions 120b adjacent to each other in the tray detachment direction Dd1 when viewed in the Y-axis direction.

As illustrated in FIGS. 11, 12B, and 21, the cartridge-side contact 270 is disposed inside the outer edge of the side surface portion 223s as viewed in the Y-axis direction, and is disposed inside (+Y side) the end surface in the Y-axis direction of the cartridge P. That is, the cartridge-side contact 270 is disposed at a position retracted in the +Y direction relative to the side surface portion 223s, which is an end surface in the −Y direction of the cartridge P. If the cartridge-side contact 270 protrudes outward relative to the end surface of the cartridge P, the cartridge-side contact 270 comes into contact with the apparatus body 1 A and is scraped off when the cartridge P is attached to or detached from the apparatus body 1A, which may result in a connection failure (electrical conduction failure). By arranging the cartridge-side contact 270 inside the end surface of the cartridge P, the possibility of a connection failure (electrical conduction failure) or the like occurring for the above-described reason can be reduced.

On the other hand, the separated position of the body-side contact 301 is set to a position retracted outward (to the −Y side) relative to an end surface in the +Y direction of the left side plate 120. This is because, if the separated position of the body-side contact 301 protrudes in the +Y direction beyond the end surface in the +Y direction of the left side plate 120, there is a possibility that the user may inadvertently contact the body-side contact 301 located at the separated position.

Here, a comparative example will be considered in which no protruding portion 120b is provided on the left side plate 120, and the end surface in the +Y direction of the left side plate 120 is constituted only by the reference surface 120a. In this case, the separated position of the body-side contact 301 is set to a position retracted outward (to the −Y side) relative to the reference surface 120a of the left side plate 120. On the other hand, a distance by which the rib shape 223r protrudes relative to the side surface portion 223s in the Y-axis direction is referred to as a rib protruding distance. The side surface portion 223s of the cartridge P is separated in the Y-axis direction from the reference surface 120a of the left side plate 120 by a length equal to or greater than the rib protruding distance. Therefore, the moving distance when the body-side contact 301 moves from the separated position to the contact position is longer than the rib protruding distance.

If the moving distance of the body-side contact 301 is increased by the rib protruding distance of the rib shape 223r as in the comparative example, the size of the printer 1 will increase in order to secure a space that allows the body-side contact 301 to move.

On the other hand, in the present example, by providing the protruding portion 120b on the left side plate 120, a part of the end surface in the +Y direction of the left side plate 120 is shifted to the +Y side with respect to the reference surface 120a. The separated position of the body-side contact 301 is set to the +Y side relative to the reference surface 120a and to the −Y side relative to the maximum protruding position of the protruding portion 120b with respect to the reference surface 120a. In other words, the separated position of the body-side contact 301 (first contact) is downstream of the first surface (reference surface 120a) of the first side plate and upstream of the maximum protruding position of the first protruding portion (protruding portion 120b) with respect to the first surface in the +Y direction (first direction). In other words, at the separated position, the first contact protrudes in the +Y direction (first direction) relative to the first surface of the first side plate, and is retracted in the −Y direction (opposite direction) relative to the maximum protruding position (Y2) of the first protruding portion with respect to the first surface. At the contact position illustrated in FIGS. 10 and 12B, the first contact may protrude in the +Y direction (first direction) beyond the maximum protruding portion position (Y2) of the first protruding portion.

That is, as illustrated in FIG. 13B, the position of the reference surface 120a in the Y-axis direction is defined as a first position Y1, the maximum protruding position of the protruding portion 120b with respect to the reference surface 120a is defined as a second position Y2, and the position of the portion closest to the cartridge-side contact 270 of the body-side contact 301 located at the separated position is defined as a position Y3. In this case, the position Y3 of the body-side contact 301 is set to a position between the first position Y1 and the second position Y2.

With this configuration, the separated position of the body-side contact 301 can be brought close to the side surface portion 223s of the cartridge P, and the moving distance of the body-side contact 301 from the separated position to the contact position can be shortened, as compared with the comparative example described above. As the moving distance of the body-side contact is shortened, the size of the printer 1 can be reduced.

Further, according to the present example, it is not necessary to set the position Y3 of the body-side contact 301 to a position away from the side surface portion 223s of the cartridge P by a rib protruding distance or more. Therefore, the position Y3 of the body-side contact 301 may be downstream in the +Y direction (first direction) beyond the maximum protruding position of the rib shape 223r (second protruding portion) with respect to the side surface portion 223s (second surface) of the cartridge P. As a result, regardless of the rib protruding distance of the rib shape 223r, the moving distance from the separated position to the contact position of the body-side contact 301 can be shortened.

Further, in the above-described comparative example, since the moving distance of the body-side contact 301 is long, the operation load when the door 20 is opened increases. That is, when the door 20 is opened, the moving member 300 moves the body-side contact 301 from the contact position to the separated position against the restoring force of the contact spring 301A. In addition, since the door 20 is connected to the moving member 300 via the link mechanism 200, the restoring force received by the moving member 300 from the contact spring 301A acts on the door 20 as a load (resistance force) resisting the opening of the door 20. The longer the moving distance of the body-side contact 301, the greater the amount of elastic deformation of the contact spring 301A, and the greater the restoring force generated by the contact spring 301A, as a result the greater the load applied to the door 20.

On the other hand, in the present example, since the moving distance of the body-side contact 301 from the separated position to the contact position can be shortened, the restoring force generated by the contact spring 301A can be reduced. As a result, an operation load can be reduced when the door 20 is opened, improving usability.

As illustrated in FIG. 13B, in a state where the tray unit 50 is inserted into the apparatus body 1A, a gap G1 between the reference surface 120a of the left side plate 120 and the rib shape 223r of the cartridge P is preferably narrower than a gap G2 between the protruding portion 120b of the left side plate 120 and the side surface portion 223s of the cartridge P (G1<G2). Due to the relationship of G1<G2, the rib shape 223r extending in a direction along the tray detachment direction Dd1 (second direction) functions as a guide portion that comes into contact with the left side plate 120 when the tray unit 50 is inserted and pulled out. As a result, it is possible to prevent the protruding portion 120b of the left side plate 120 from coming into contact with the side surface portion 223s of the cartridge P. Accordingly, the tray unit 50 can be inserted and pulled out more smoothly, further improving usability.

### Modification

In the above-described example, the configuration in which the cartridge P is attached to and detached from the apparatus body 1A via the tray 51 has been exemplified. That is, the configuration in which the cartridge P can be attached to and detached from the tray 51 inserted into and pulled out from the apparatus body 1A, and the cartridge P is accommodated in the apparatus body 1A in a state where the cartridge P is supported by the tray 51 has been exemplified. Not limited thereto, for example, the cartridge Pin the above- described example may be fixed to the tray 51, and the cartridge P (process unit) may be attached to and detached from the apparatus body 1A as a part of the tray 51.

Further, the printer 1 may not include the tray 51, and the cartridge P may be directly attached to and detached from the apparatus body 1A without passing through the tray 51.

Further, in the above-described example, the printer 1 including the four cartridges PY to PK has been exemplified, but the printer 1 may include only one cartridge P. That is, the printer 1 may be a monochrome image forming apparatus.

According to the present disclosure, it is possible to provide a new technology related to bringing a casing-side contact and a cartridge-side contact of the image forming apparatus into contact with each other.

### Other Embodiments

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-111319, filed Jul. 10, 2024, which is hereby incorporated by reference herein in its entirety.

What is claimed is:

1. An image forming apparatus comprising:
a casing;
a cartridge detachably attached to the casing;
a first contact disposed in the casing; and
a second contact disposed in the cartridge and configured to electrically connect the cartridge and the casing by contact with the first contact,
wherein the casing includes a first side plate and a second side plate between which a space to accommodate the cartridge is formed,
wherein the first side plate includes a first surface facing a first direction, which is a direction from the first side plate toward the second side plate, and a first protruding portion protruding in the first direction with respect to the first surface,
wherein the cartridge includes a second surface facing an opposite direction opposite to the first direction and a second protruding portion protruding in the opposite direction with respect to the second surface, and is configured such that the first protruding portion faces the second surface and the second protruding portion faces the first surface in a state where the cartridge is attached to the casing,
wherein the second contact is disposed inside an outer edge of the second surface when viewed in the first direction and is retracted in the first direction relative to the second surface,
wherein the first contact is movable between a contact position, where the first contact is in contact with the second contact, and a separated position, where the first contact is separated from the second contact in the opposite direction, and
wherein at the separated position, the first contact protrudes in the first direction relative to the first surface, and is retracted in the opposite direction relative to a maximum protruding position of the first protruding portion with respect to the first surface.

2. The image forming apparatus according to claim 1,
wherein at the contact position, the first contact protrudes in the first direction relative to the maximum protruding position of the first protruding portion.

3. The image forming apparatus according to claim 1,
wherein an opening is formed in the casing, and
wherein the image forming apparatus further comprises:
an opening/closing member movable with respect to the casing between a closed position, where the opening/closing member covers the opening, and an opened position, where the opening/closing member allows the opening to be exposed; and
a moving member configured to move the first contact from the contact position to the separated position in conjunction with a movement of the opening/closing member from the closed position to the opened position, and move the first contact from the separated position to the contact position in conjunction with a movement of the opening/closing member from the opened position to the closed position.

4. The image forming apparatus according to claim 3, further comprising:
an elastic member configured to be elastically deformable in the first direction and in the opposite direction,
wherein the first contact is provided at an end of the elastic member in the first direction,
wherein in a case where the opening/closing member moves from the closed position to the opened position, the moving member is configured to move the first contact from the contact position to the separated position against a restoring force of the elastic member, and
wherein in a case where the opening/closing member moves from the opened position to the closed position, the moving member is configured to allow the first contact to move from the separated position to the contact position by the restoring force of the elastic member.

5. The image forming apparatus according to claim 4, further comprising:
a link mechanism configured to connect the opening/closing member and the moving member to each other and move the moving member in conjunction with a movement of the opening/closing member.

6. The image forming apparatus according to claim 3, further comprising:
a tray configured to support the cartridge, movable in a second direction intersecting the first direction, and configured to be inserted into and pulled out from the casing through the opening,
wherein the second protruding portion has a rib shape extending in a direction along the second direction, and
wherein in a state where the cartridge is attached to the casing, a gap between the second protruding portion and the first surface in the first direction is narrower than a gap between the first protruding portion and the second surface in the first direction.

7. The image forming apparatus according to claim 6, further comprising:
a plurality of cartridges including the cartridge, each of the plurality of cartridges being attachable to and detachable from the tray,
wherein the first side plate has a plurality of first protruding portions including the first protruding portion, the plurality of first protruding portions corresponding to the plurality of cartridges, respectively, and
wherein the plurality of first protruding portions are arranged in the second direction.

8. The image forming apparatus according to claim 7,
wherein the first side plate has an opening portion formed between the plurality of first protruding portions in the second direction, and
wherein the first contact is disposed inside the opening portion when viewed in the first direction.

9. The image forming apparatus according to claim 6,
wherein the cartridge includes a storage medium disposed on an end surface of the cartridge in a third direction intersecting both the first direction and the second direction, the storage medium including an upstream end in the first direction, and
wherein the first contact and the second contact are configured to be in contact with each other at a position downstream of the upstream end of the storage medium in the first direction.

10. The image forming apparatus according to claim 1,
wherein at the separated position, the first contact is located downstream, in the first direction, of a maximum protruding position of the second protruding portion with respect to the second surface.

11. The image forming apparatus according to claim 1,
wherein the second protruding portion has a rib shape extending in a direction intersecting the first direction.

12. The image forming apparatus according to claim 1,
wherein the cartridge includes a charging member configured to charge an image bearing member by applying a voltage to the charging member via the first contact and the second contact.

13. The image forming apparatus according to claim 1,
wherein the cartridge includes a developing member configured to supply a developer to an image bearing member by applying a voltage to the developing member via the first contact and the second contact.

14. The image forming apparatus according to claim 1,
wherein the cartridge includes a container configured to contain a developer, and an electrode member disposed in the container,
wherein the casing includes a detection circuit configured to detect an amount of the developer contained in the container using the electrode member, and
wherein the detection circuit and the electrode member are electrically connected to each other via the first contact and the second contact.

15. The image forming apparatus according to claim 1,
wherein the cartridge includes a storage medium configured to store information about the cartridge,
wherein the casing includes a control unit configured to read the information from the storage medium, and
wherein the control unit and the storage medium are electrically connected to each other via the first contact and the second contact.

16. The image forming apparatus according to claim 1,
wherein the first side plate is a sheet metal, and
wherein the first surface and the first protruding portion are integrally formed with the sheet metal.

17. The image forming apparatus according to claim 1,
wherein the casing includes a stay extending in the first direction and connected to both the first side plate and the second side plate, and
wherein the first surface of the first side plate is connected to the stay.

18. The image forming apparatus according to claim 1,
wherein the cartridge includes a photosensitive drum configured to rotate about a rotation axis, and
wherein the first direction is parallel to a direction of the rotation axis.
